(19) United States
(12) Patent Application Publication
(10) Pub. No.: US 2026/0301259 A1
(43) Pub. Date: Oct. 1, 2026

(54) METHODS AND SYSTEMS FOR PERSONALIZED CONTENT DESCRIPTIONS BASED ON VISUAL IMPAIRMENT

(71) Applicant: Adeia Guides Inc., San Jose, CA (US)

(72) Inventors: Aldis Sipolins, Somerville, MA (US); Ning Xu, Irvine, CA (US); Jean-Yves Couleaud, Mission Viejo, CA (US); Mareeta Mathai, San Jose, CA (US)

(21) Appl. No.: 19/095,854

(22) Filed: Mar. 31, 2025

(51) Int. Cl. G06T 11/60; G06T 5/20; G06V 10/44; G06V 10/56; G06V 10/60; G06V 20/70

(52) U.S. Cl. CPC G06T 11/60; G06T 5/20; G06V 10/44; G06V 10/56; G06V 10/60; G06V 20/70; G06V 2201/07

(57) ABSTRACT

Systems and methods are described herein for adapting content descriptions to specific types of visual impairments, such as colorblindness and contrast insensitivity. The disclosed techniques may generate simulated content based on one or more types of visual impairments and dynamically identify objects and/or regions whose visual presentation is affected by the visual impairment. The disclosed techniques may prioritize the affected objects and/or regions within the content to output tailored descriptions relevant to the one or more specific visual impairments.

### BACKGROUND

This disclosure is related to systems and methods for generating tailored descriptions for visually impaired users. In particular, the disclosure relates, in part, to selectively prioritizing visual regions of media content based on a visual impairment to provide personalized descriptions.

### SUMMARY

Visual impairments affect millions of adults with varying degrees of severity and types. Conditions such as contrast sensitivity issues, protanopia (red-green color blindness), deuteranopia (another form of red-green color blindness), tritanopia (blue-yellow color blindness), and monochromacy (complete color blindness) can significantly affect daily activities. For instance, individuals with contrast insensitivity may struggle to distinguish objects in low-light conditions, making driving or navigating dimly lit areas challenging. Those individuals with color vision deficiencies may have difficulty identifying traffic lights, distinguishing between certain foods, or interpreting color-coded information. These impairments can affect both personal and professional aspects of life, impacting safety, independence, and overall quality of life.

Systems have enabled the generation of assistive technology that helps individuals with visual impairments navigate the world more independently and effectively. One such tool is alt-text, or alternative text, which provides a written description of images, graphics, and other visual content. For example, for those with color blindness or contrast insensitivity, alt-text ensures that visual elements on websites, applications, and digital documents can still be understood. In some approaches, alt-text is designed to be understood by screen readers. Generally, a screen reader is a software tool designed to assist individuals with visual impairments by converting digital content, such as alt-text, into speech. Screen readers may rely on alt-text to convey the content and meaning of images to users who are visually impaired. The alt-text provides a description that the screen reader reads aloud, helping users understand what the image represents.

In one approach, alt-text are written manually. For instance, in situations where automatically generated descriptions may miss the nuances of the visual content, written descriptions may manually be created to ensure that the content and context of the image is accurately portrayed. However, manually writing the description for various content is a time-consuming and resource intensive process.

In another approach, alt-text are generated automatically using machine learning and computer vision algorithms. For example, if an image shows a person sitting on a bench in the park, the system might generate an alt-text such as “a person sitting on a park bench with trees in the background,” helping individuals understand the image via screen readers. In some approaches, screen readers read aloud these descriptions, enabling individuals to access information that would otherwise be inaccessible. However, in such approaches, the alt-text may be too vague or may not adequately describe the image, leaving out important context.

Additionally, visual impairment is a spectrum, and many visually impaired individuals do not need every part of the image described. For example, an individual with red-green colorblindness may need a different part of the image described than an individual with contrast insensitivity.

Consequently, current alt-text is inefficient because the alt-text description is the same, regardless of the viewer's specific visual impairment, meaning that the alt-text includes descriptions of elements that the viewer is able to properly perceive as well as elements the viewer cannot properly perceive. This leads to unnecessarily long alt-text descriptions that miss critical parts of an image and include unnecessary descriptions. Additionally, generating long alt-text descriptions significantly increases demand on the server which leads to expending additional bandwidth causing longer processing times and slower page load times for devices attempting to access the content.

Accordingly, to help address such problems, systems and methods are provided herein, wherein an illustrative system prioritizes visual regions selectively based on an individual's visual impairment to generate tailored descriptions (e.g., alt-text) for visually impaired individuals. In some embodiments, the system determines that a visual presentation of an object depicted in content (e.g., an image) is impacted by a visual impairment corresponding to a computing device (e.g., a computing device operated by a user having the visual impairment) and outputs a description of the content focusing on the object impacted by the visual impairment. In some embodiments, the system comprises a computing device, and at least one server. Devices of the system may execute an alternative content description (“ACD”) application. In some embodiments, for example, the ACD application may be executed at least in part on the computing device, and/or at one or more remote servers. In some embodiments, the ACD application is executed when a processing circuitry executes instructions store in a non-transitory memory that when executed causes performance of steps described herein.

In some embodiments, a first image is received. In some embodiments, a machine learning model, as part of executing the application, determines a first object of importance within the first image. In some embodiments, a first object of importance is determined within the first image using image processing techniques (e.g., edge detection, thresholding, contour detection, region-based segmentation, feature extraction, object recognition or classification, etc.). In some embodiments, the image is associated with metadata. In some embodiments, the first object of importance is determined based on metadata associated with the image. In some embodiments, an object of importance may be determined using machine learning techniques, image processing techniques, metadata, a combination of any of the techniques described herein or any other techniques that are used to identify an object(s) within a content item. In some embodiments, a visual impairment qualifier corresponding to the computing device is identified.

In some embodiments, using the machine learning model, a second image is generated based on the visual impairment qualifier and the first image. In some embodiments, based at least in part on a comparison of the first image to the second image, it is determined that a visual presentation of the first object within the first image is greater than a threshold difference from a visual presentation of the first object within the second image. In this context, the “distance” between the first object in the first image and the second image may refer to a measure of whether the visual presentation of the object in the first image is sufficiently different from the visual presentation of the object in the second image. That is, the distance may correspond to a determination of whether the difference in visual presentation between the object in the first image and the object in the second image would be noticeable to an individual having the identified visual impairment. In some embodiments, based at least in part on determining that the visual presentation of the first object is greater than the threshold difference from the visual presentation of the first object within the second image, a first description of the first image is output, where the first description comprises details about the first object and is based on the visual impairment qualifier.

In some embodiments, the ACD system determines that a visual presentation of an object within the first input image is impacted based on the visual impairment qualifier, without the generation and comparison of the second, simulated image. In some embodiments, the ACD system may define color ranges (e.g., red, green, and/or yellow color ranges) based on a visual impairment type (e.g., protanopia color blindness) to analyze whether within the first, input image there is any object within these defined color ranges. For example, a visual impairment type identified as protanopia color blindness primarily impacts the perception of red hues. Individuals with this type of visual impairment have difficulty distinguishing between colors that contain red wavelengths (e.g., red hues mixed with green may be perceived as a grayish or brownish color, making it hard to differentiate between red and green). Therefore, an image portraying a bright red apple might look more like a brownish or dark gray object, especially when placed against a colored background like green grass. In some embodiments, if it is determined that an object is within defined color ranges within the first, input image, the ACD system may generate a content description focusing on those objects, without generating a second image to be compared to the original image. For example, if the ACD system determines that the red apple shown within the first, input image is against a green background, the ACD system, may therefore determine that since the red apple is located within the defined color range (e.g., red, green, and yellow color ranges) for a visual impairment type of protanopia, the content description focuses on the red apple and the green background when generating the alt-text.

The example systems and methods described herein help to overcome the deficiencies in existing solutions. Such aspects enable the system to provide profile-based tailored content descriptions with visual impairment indicators enabling the system to prioritize elements within content that are highly relevant to a specific visual challenge. The method described herein for the ACD system providing tailored descriptions relevant to a visual impairment, ensures that only necessary or particularly relevant/helpful information is generated, enhancing efficiency by reducing the amount of data processed and delivered. Providing tailored content descriptions helps to avoid overloading the system with irrelevant details, focusing solely on relevant elements. The methods described herein for the ACD system help to minimize storage burden on devices allowing devices to, for example, cache tailored descriptions for frequently viewed images. These techniques further help to reduce the need to reprocess or generate new content descriptions with each content load.

In some embodiments, the visual impairment identifier or qualifier corresponds to a color blindness visual impairment. For example, the color blindness visual impairment may be protanopia, deuteranopia, tritanopia, and/or monochromacy. In some embodiments, the second image is generated by transforming (e.g., using a processing filter, such as Long-Medium-Short (LMS) color space or Commission Internationale de l'Eclairage (CIE) Lab) the first image into a uniform color space. In some embodiments, using the machine learning model, the first image is modified with a visual impairment matrix, wherein the visual impairment matrix is based on the visual impairment qualifier. For example, a visual impairment matrix based on a visual impairment qualifier of protanopia, may modify the first image by reducing or removing the sensitivity to red light, altering the colors in the image to simulate how red hues blend into greens or greys.

In some embodiments, the visual impairment qualifier corresponds to a color blindness visual impairment and the comparison of the first image to the second image further comprises identifying the first object of importance within the second image. For example, a red apple is identified as the object of importance within the first image and is also identified within the second image. In some embodiments, a color difference between the first object of importance within the first image and the first object of importance within the second image is calculated. For example, the system may calculate color differences between the first object of importance within the first image and the first object of importance within the second image by using metrics such as Delta E, which quantifies the difference between two colors. In some embodiments, based at least in part on determining that the color difference is above a threshold, determining that the visual presentation of the first object within the first image is greater than the threshold difference from the visual presentation of the first object within the second image.

In some embodiments, a region of importance of a plurality of regions of the first image is predicted, using a machine learning model, based on a color, texture, or spatial layout of the region being visually distinguishable from one or more other regions of the plurality of regions. For example, the system may employ a saliency detection model and cross reference saliency maps with color analysis results to ensure that the object is of both visual and contextual importance. In some embodiments, it is determined that the first object of importance is located within the region of importance. In some embodiments, based at least in part on determining that the first object of importance is located within the region of importance and determining that the visual presentation of the first object within the first image is greater than the threshold difference from the visual presentation of the first object within the second image, the first description of the first image is modified to include the details of the first object of importance and the region of importance.

In some embodiments, the visual impairment qualifier corresponds to a contrast insensitivity visual impairment. In some embodiments, generating the second image comprises transforming, using a processing filter, the first image into a luminance-based color space.

In some embodiments, the visual impairment qualifier corresponds to a contrast insensitivity visual impairment and the comparison of the first image to the second image further comprises identifying a second object of importance within the second image. In some embodiments, one or more low contrast regions of a plurality of regions within the second image are determined using the machine learning model. In some embodiments, the second object of importance is determined to be within the one or more low contrast regions. In some embodiments, based at least in part on determining that the second object of importance is within the one or more low contrast regions, and that the visual presentation of the first object within the first image is greater than the threshold difference from the visual presentation of the first object within the second image, the method or processes cause to be output the first description of the first image comprising the details about the first object and the second object.

In some embodiments, the visual impairment qualifier corresponds to a contrast insensitivity visual impairment, and the comparison of the first image to the second image further comprises identifying the first object of importance within the second image. In some embodiments, a brightness difference between the first object of importance within the first image and the first object of importance within the second image is calculated. In some embodiments, based at least in part on determining that the brightness difference is above a threshold, the method or processes determine that the visual presentation of the first object within the first image is greater than the threshold difference from the visual presentation of the first object within the second image.

In some embodiments, receiving the first image further comprises receiving a second description comprising alt-text corresponding to the first image, and wherein the second description is different from the first description. In some embodiments, data comprising the second description and the visual impairment qualifier is transmitted to a service. In some embodiments, the first description of the first image is received from the service. In some embodiments, the alt-text corresponding to the first image with the first description is replaced.

In some embodiments, the computing device is caused or instructed to cache the first description of the first image. For example, when the same picture/URL and profile information is transferred or communicated, the computing device checks if it has previously cached the alt-text for that image, and if so, returns the cached alt-text which reduces the need for repeated requests to a web service for the generation of alt-text.

In some embodiments, the first description of the first image comprises a unique visual qualifier, wherein the unique visual qualifier corresponds to the details about the first object. In some embodiments, the unique visual qualifier comprises at least one of a color, a pattern, a shape, or a label. For example, the objects within the image that have been identified as visually challenging based on the visual impairment type, may be outlined in a gold color and the relevant parts of the modified alt-text may also be output in the gold color. In some embodiments, if two or more colors are described within the modified alt-text, the two or more colors may be displayed in different colors, considering the accessibility profile associated with the user. For example, in an image displaying a bowl filled with different color tomatoes, the red and green tomatoes may be identified as a problematic area based on an identified visual impairment associated with a computing device. In some embodiments, the modified alt-text of “red” may be displayed in a gold color along with the outline of the red tomato also being displayed in a gold color. Whereas the modified text of “green” may be displayed in a blue color along with the outline of the green tomato also being displayed in the blue color. In some embodiments, the modified alt-text corresponding to the areas identified as problematic within the image may be identified by a highlighting, shading, fill pattern, font, or any other stylistic changes to enable the identification what part of the image corresponds to the modified alt-text.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic example of creating tailored descriptions of content based on a visual impairment, in accordance with some embodiments of this disclosure.

FIG. 2 is a schematic example of creating tailored descriptions of content based on a visual impairment, in accordance with some embodiments of this disclosure.

FIG. 3 show an illustrative sequence diagram for creating tailored descriptions of content based on a visual impairment, in accordance with some embodiments of this disclosure.

FIG. 4 shows an illustrative sequence diagram for creating tailored descriptions of content based on a visual impairment corresponding to a color blindness visual impairment, in accordance with some embodiments of this disclosure.

FIG. 5 shows an illustrative sequence diagram for creating tailored descriptions of content based on a visual impairment corresponding to a contrast insensitivity visual impairment, in accordance with some embodiments of this disclosure.

FIG. 6 shows an illustrative sequence diagram for utilizing saliency prediction networks to generate tailored descriptions of content, in accordance with some embodiments of this disclosure.

FIG. 7 shows an illustrative example of a graphical interface to manage a visual impairment corresponding to a computing device, in accordance with some embodiments of this disclosure.

FIG. 8 shows illustrative devices and systems for creating tailored descriptions of content based on a visual impairment, in accordance with some embodiments of this disclosure.

FIG. 9 shows illustrative devices and systems for creating tailored descriptions of content based on a visual impairment, in accordance with some embodiments of this disclosure.

FIG. 10 shows an illustrative sequence diagram for a web browser including dynamic tailored description generation for content based on a visual impairment, in accordance with some embodiments of this disclosure.

FIG. 11 is an illustrative example of a retail webpage implementing a shopper profile to alter descriptions based on a visual impairment, in accordance with some embodiments of this disclosure.

FIG. 12 is an illustrative example of a graphical interface generating tailored descriptions of content based on a visual impairment corresponding to a color blindness visual impairment, in accordance with some embodiments of this disclosure.

FIG. 13 is a flowchart of a detailed illustrative process for creating tailored descriptions of content based on a visual impairment corresponding to a color blindness visual impairment, in accordance with some embodiments of this disclosure.

### DETAILED DESCRIPTION

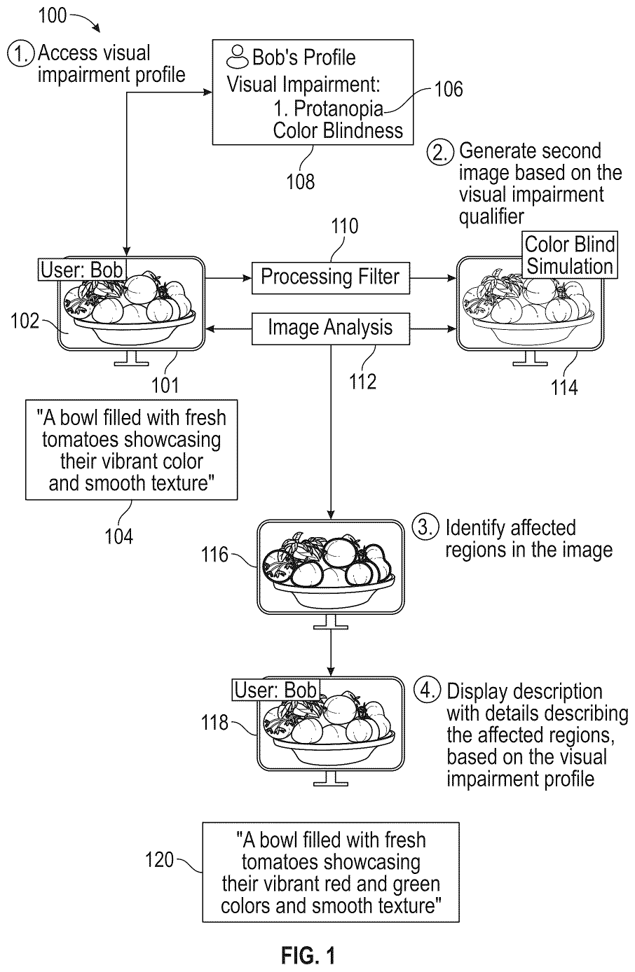

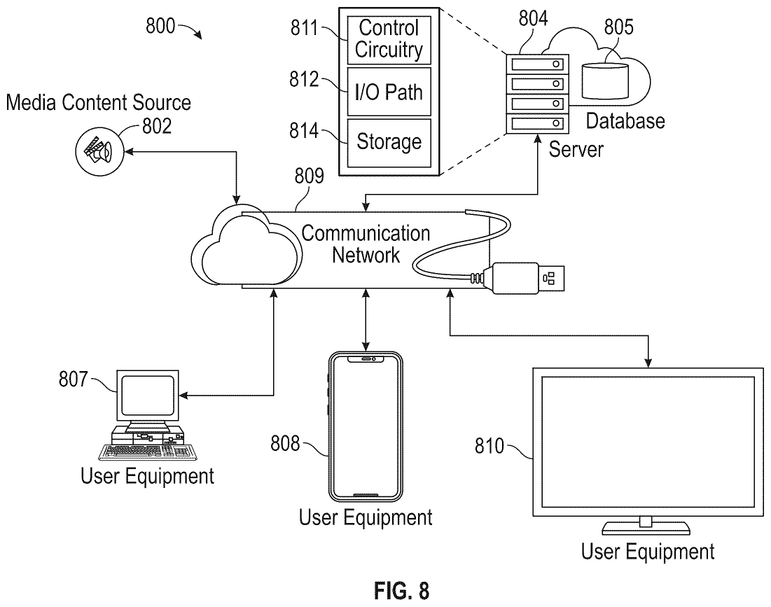

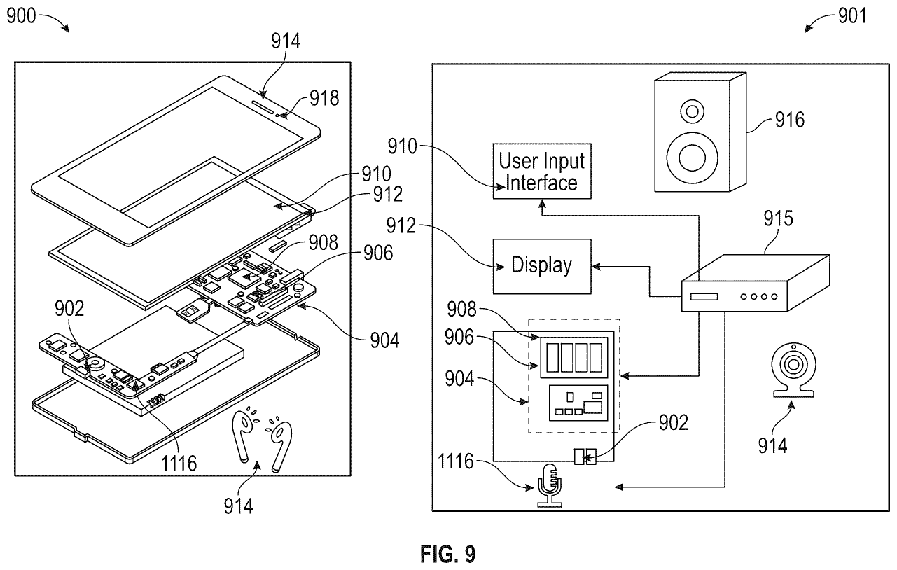

FIG. 1 is a schematic example of creating tailored descriptions of content based on a visual impairment 100, in accordance with some embodiments of this disclosure. In some embodiments, an alternative content description system 100 (referred to herein as the “ACD system”) comprises or corresponds to at least one computing device 101 and at least one server, or any other suitable platform, or any combination thereof. In some embodiments, the ACD system may comprise an ACD application, that is executed when a processing circuitry executes instructions stored in a non-transitory memory that when executed causes performance of steps described herein. The ACD system may be executed at least in part on the at least one computing device, and/or at one or more remote servers (e.g., server 804 of FIG. 8 and/or media content source 902 of FIG. 9). The ACD system may be distributed across any of one or more other suitable computing devices, in communication over any suitable number and/or types of networks (e.g., the Internet). The ACD application may be configured to perform the functionalities (or any suitable portion of the functionalities) described herein. In some embodiments, the ACD application and/or the ACD system is a standalone application, or is incorporated as part of any suitable application or system, e.g., a content creation and/or content editing application; a web browsing application; a social media application; a content provider application; a 2D application; an extended reality (XR) application; a supplemental content provider; a content acquisition, recognition and/or processing application; a machine learning model or AI system; or any other suitable application or system; or any combination thereof. The ACD application and/or ACD system may comprise or employ any suitable number of displays; sensors or devices such as those described in FIGS. 1-13; or any other suitable software and/or hardware components; or any suitable combination thereof.

In some embodiments, the ACD system may be installed at or otherwise provided to a particular computing device, may be provided via an API, or may be provided as an add-on application to another platform or application. In some embodiments, software tools (e.g., one or more software development kits, or SDKs) may be provided to any suitable party, to enable the party to implement the functionalities described herein.

As shown in FIG. 1, the computing device 101 receives an image 102. In some embodiments, an image 102 and a description of the image 104 (e.g., “A bowl filled with fresh tomatoes showcasing their vibrant color and smooth texture”) is received (e.g., in HTML at a web browser from a website). In one example, the computing device 101 is logged into using the credentials of an application, a webpage, or an account associated with a service provider. In some embodiments, the credentials used to log into an application, a webpage, or an account associated with a service provider corresponds to a profile 108 (e.g., Bob's profile). In some embodiments, the profile corresponds to a visual impairment qualifier 106 (e.g., Protanopia Color Blindness).

In some embodiments, the ACD system transforms the image 102 into simulated image 114 based on the identified corresponding visual impairment 106. In one embodiment, a processing filter 110 is used to modify the image with a colorblindness simulation matrix, customized for a specific type of colorblindness. For example, as shown in this illustrative example, the processing filter 110 modifies the original image 102 with a protanopia color blindness simulation matrix to produce a simulated image 114 by reducing or removing the sensitivity to red light, altering the colors in the image 102 to simulate how red hues blend into greens or grays.

In some embodiments, once the simulated image 114 is generated the ACD system performs a comparative analysis between the original image 102 and the simulated image 114 to calculate color differences to identify areas of the image where color differences are significant. In some embodiments, the areas where the color differences are significant, these areas are flagged as visually challenging based on the identified visual impairment 106 associated with the profile 108 (e.g., protanopia color blindness).

In some embodiments, the ACD system does not need to generate the simulated image 114 to identify areas of the image where color differences are significant. In some embodiments, the ACD system may store comparative analysis data (e.g., identification of areas of the image where color differences are significant) between the original image 102 and simulated image 114. In some embodiments, the ACD system may utilize the stored comparative analysis data to analyze the original image 102 (e.g., the ACD system utilizes stored prior comparative analysis data). For example, a visual impairment associated with a particular colorblindness primarily impacts the perception of certain color ranges, and therefore the ACD system may utilize prior comparative analysis data associated with the particular visual impairment to analyze an original, input image (e.g., original image 102). In this illustrative example, Bob's protanopia color blindness impacts the perception of red, green, and yellow color ranges. Therefore, if the ACD system has previously analyzed other content based on a visual impairment type of protanopia color blindness and/or a severity associated with the visual impairment type, the ACD system may utilize stored prior comparative analysis data to analyze the original image 102 and avoid repetitive generation of simulated images. In some embodiments, the ACD system, using stored comparative analysis data to analyze an input image (e.g., original image 102), may generate, select, or apply content descriptions focusing on the identified object impacted by the visual impairment type.

In some embodiments, the ACD system determines that a visual presentation of an object within the original image 102 is impacted based on the visual impairment 106 associated with the profile 108, without generating the simulated image 114. In some embodiments, the ACD system may define color ranges (e.g., red, green, and/or yellow color ranges) based on a visual impairment type (e.g., protanopia color blindness) and a severity of the visual impairment to check whether within the first, input image there is any object within these defined color ranges. In some embodiments, if it is determined that an object is within defined color ranges within the first, input image, the ACD system may generate a content description focusing on those objects without first generating a simulated image.

In some embodiments, an image analysis model 112 of the ACD system identifies and localizes objects in the image by drawing boxes or segmentation masks around the objects. In some embodiments, for each identified object, the ACD system performs localized color analysis, assessing the color variations within the object and the impact of the colorblindness on those variations 116. For example, as shown in this illustrated example, the ACD system, using the image analysis model 112, has identified tomatoes in a bowl. In this example, the ACD system assesses the color variations within each of the identified tomatoes to determine the impact of the protanopia color blindness 106 corresponding to Bob's profile 108. The ACD system determines that the green tomato and the red tomatoes appear similar in the color-blind simulation 114.

In some embodiments, the ACD employs a saliency detection model, to predict which regions of an image are likely of importance based on identifying prominent pixels that stand out due to the pixel's distinct visual features. In some embodiments, the prediction is based on a variety of distinct visual features like color contrast, intensity contrast, edge detection, center bias, texture, local versus global features, depth and focus, motion and temporal features, semantic features, spatial layout, etc. It should be understood that this list is provided as an example and may include other features typically used in a saliency detection model. It should also be understood that the saliency detection model may combine multiple features into a single framework to predict an area of importance within the image. In some embodiments, the ACD system cross-references saliency maps with the color analysis results to ensure that objects of both visual and contextual importance are prioritized.

In some embodiments, the ACD system modifies the original alt-text 104, for example, using a natural language generation (NLG) system. In some embodiments, the ACD system combines the results from the image analysis 112, the colorblind simulation 114, object segmentation model, and saliency analysis detection model to generate tailored descriptions 120. For example, the original alt-text 104 “a bowl filled with fresh tomatoes showcasing their vibrant color and smooth texture,” is replaced by the ACD system with tailored alt-text, “a bowl filled with fresh tomatoes showcasing their vibrant red and green colors and smooth texture,” based on the visual impairment 106 corresponding to the profile 108 which reflects the challenging part of the scene to a protanopia color blindness visual impairment.

In some embodiments, the ACD system can apply the same framework as discussed above to a video by analyzing key frames extracted using, for example, shot boundary detection or scene segmentation. In some embodiments, the ACD system applies the same colorblindness simulation techniques discussed above to each frame. In some embodiments, the ACD system uses temporal analysis, such as optical flow, to track objects and their properties (e.g., contrast color) across each frame to maintain consistency in audio description text (e.g., descriptive audio metadata or descriptive subtitles). In some embodiments, the ACD system utilizes dynamic adjustments, such as adaptive histogram equalization, to address low-contrast regions, while significant visual events (e.g., object movements or color changes) are prioritized using event detection algorithms. In some embodiments, the ACD system will generate audio description text (e.g., descriptive audio metadata or descriptive subtitles) with time-stamped descriptions focusing on critical moments, such as “at 0:15, a dark car moves across the parking lot,” ensuring accessibility tailored to both temporal and perceptual challenges in video content.

In some embodiments, the ACD system can identify similar objects of different colors using a combination of object detection models, segmentation models, and color analysis techniques. In some embodiments, the ACD system detects objects in an image using machine learning models such as, Faster R-CNN or You Only Look Once (“YOLO”). In some embodiments, the ACD system refines the object detection analysis through segmentation models, such as Mask R-CNN, to precisely isolate individual objects. In some embodiments, non-color features such as shape, size, and texture are extracted using pre-trained convolutional neural networks (CNNs) (e.g., ResNet or MobileNet) to group objects with similar structural characteristics. For example, objects such as an apple, regardless of color, are grouped based on their shared physical attributes. In some embodiments, once the objects are grouped, the ACD system differentiates the objects within these groups by analyzing the color properties associated with each object in a perceptually uniform color space (e.g., CIE Lab). In some embodiments, the ACD system employs clustering algorithms (e.g., K-Means) to identify dominant colors within each object, allowing the ACD system to distinguish objects by the color differences. For example, red and green apples are identified as similar in shape but distinct in color. In some embodiments, contextual relevance of the object within the image is further considered using saliency detection models to prioritize meaningful distinctions, such as red and green traffic lights in a road scene over applies in a grocery image. In some embodiments, the ACD system generates alt-text that highlights both the similarity and the color differences. For example, alt-text descriptions such as “a red apple and a green apple in a basket” or “a red and a green traffic light at the intersection,” would be generated to ensure accurate, context-sensitive descriptions.

In some embodiments, the ACD system may alter an image or a video for output, based on the visual impairment qualifier corresponding to the visual profile. In some embodiments, the ACD system, using the generated alt-text for an image or a video segment, may prompt a generative AI text-to-image or text-to-video model. In some embodiments, the generative AI text-to-image or text-to-video model may be guided (i.e., conditioned) by the original image or video so that only portions identified by the alt-text as relevant are enhanced.

In some embodiments, the ACD system may evaluate multiple images and present the image that requires the least modification based on an identified visual impairment associated with a computing device. For example, an image carousel may present the images that require the least modification before presenting the image to the ACD system.

In some embodiments, the identified vision impairment type corresponding to the computing device may influence advertisement selection. In some embodiments, the ACD system analyzes candidate advertisements to identify those that require the least modification to the corresponding description based on the visual impairment corresponding to the computing device and prioritizes those advertisements. For example, the ACD system may receive multiple original advertisements. In some embodiments, the ACD system analyzes each of the received original advertisements to determine which original advertisement would require the least modification based on an identified visual impairment. In some embodiments, the ACD system determines which original alt-text corresponding to the advertisement would require the least modification based on the identified visual impairment. In some embodiments, the ACD system determines which original image and/or video corresponding to the original advertisement would require the least modification based on the identified visual impairment. In some embodiments, the ACD determines both of which original alt-text and original image and/or video corresponding to the original advertisement requires the least amount of modification based on the visual impairment.

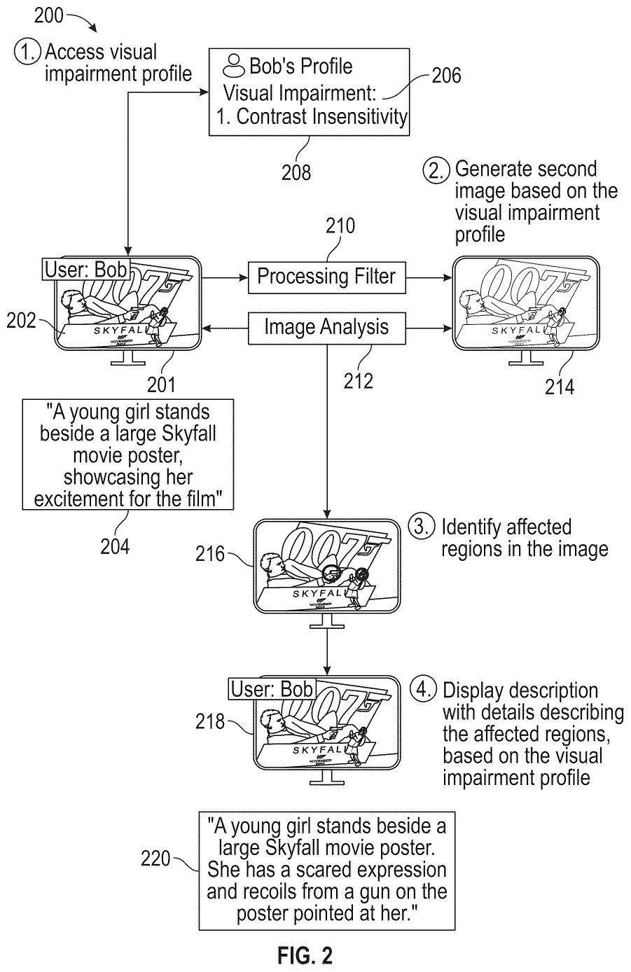

FIG. 2 is a schematic example of creating tailored descriptions of content based on a visual impairment, in accordance with some embodiments of this disclosure 200.

In some embodiments, the computing device 201 receives an image 202. In some embodiments, an image 202 and a description of the image 204 (e.g., “A young girl stands beside a large Skyfall movie poster, showcasing her excitement for the film”) is received (e.g., in HTML at a web browser from a website). In one example, the computing device 201 is logged into using the credentials of an application, a webpage, or an account associated with a service provider. In some embodiments, the credentials used to log into an application, a webpage, or an account associated with a service provider corresponds to a profile 208 (e.g., Bob). In some embodiments, the profile corresponds to a visual impairment qualifier 206 (e.g., Contrast Insensitivity).

In some embodiments, the ACD system transforms the image 202 into simulated image 214 based on the identified corresponding visual impairment 206. In one embodiment, a processing filter 210 is used to modify the image into a luminance-based color space. For example, as shown in this illustrative example, the processing filter 210 modifies the original image 202 into a luminance-based color space to produce a simulated image 214 by separating brightness from chromatic information. In some embodiments, the ACD system performs a comparative analysis between the original image 201 and the simulated image 214, using for example, image analysis models 212, and calculates pixel-level brightness gradients and highlights regions with low contrast.

In some embodiments, the ACD system does not need to generate the simulated image 214 to identify areas of the image where brightness level differences are significant. In some embodiments, the ACD system may store comparative analysis data (e.g., identification of areas of the image where brightness differences are significant) between the original image 202 and simulated image 214. In some embodiments, the ACD system may utilize the stored comparative analysis data to analyze the original image 202. For example, a contrast insensitivity visual impairment primarily impacts the ability to distinguish objects from their background based on differences in light and dark, and therefore the ACD system may utilize prior comparative analysis data associated with the particular visual impairment to analyze an original, input image (e.g., original image 202). In this illustrative example, Bob's contrast insensitivity impacts the ability to see the gun on the poster and the girls scared expression due to dark backgrounds. Therefore, if the ACD system has previously analyzed other content based on a visual impairment type of contrast insensitivity and/or a visual impairment severity, the ACD system may utilize stored prior comparative analysis data to analyze the original image 202 and avoid repetitive generation of simulated images. In some embodiments, the ACD system, using stored comparative analysis data to analysis an input image (e.g., original image 202), may generate, select, or apply content descriptions focusing on the identified object impacted by the visual impairment type.

In some embodiments, the ACD system determines that a visual presentation of an object within the original image 202 is impacted based on the visual impairment 206 associated with the profile 208, without generating the simulated image 214. In some embodiments, the ACD system may define contrast and/or brightness ranges based on a visual impairment type and a severity of the visual impairment type to check whether within the first, input image there is any object within these defined contrast/brightness ranges. In some embodiments, if it is determined that an object is within defined contrast/brightness ranges within the first, input image, the ACD system may generate a content description focusing on those objects without first generating a simulated image.

In some embodiments, the ACD system applies a saliency detection algorithm to consider luminance differences. For example, the ACD system can use saliency models (e.g., DeepGaze or GBVS) to predict regions of the image that are likely of importance based on the context of the image, brightness, and edge information. In some embodiments, the saliency detection algorithms are modified to focus specifically on areas with low contrast. In some embodiments, the ACD system generates a heatmap to visualize regions with insufficient tonal separation, marking these areas as challenging for users with contrast insensitivity.

In some embodiments, once the ACD system has identified low-contrast areas, the system applies object detection algorithms (e.g., Mask R-CNN or Faster R-CNN), to locate objects within these areas 216. As shown in this illustrative example, the ACD system has identified the young girl's expression and the gun as regions affected by the contrast insensitivity visual impairment. In some embodiments, objects partially or fully obscured by low contrast are prioritized for detailed description. In some embodiments, where object boundaries are blurred due to insufficient contrast, the ACD system utilities edge-detection algorithms (e.g., Canny Edge Detection) to refine object segmentation. In some embodiments, the ACD system applies object detection algorithms before or in parallel with the identification of low-contrast areas.

In some embodiments, the ACD system filters areas within an image based on their contextual importance using semantic segmentation models (e.g., DeepLab or U-Net) to segment the image into meaningful areas (e.g., sky, ground, building, objects). In some embodiments, the ACD system combines the contrast data with semantic understanding to prioritize areas most likely to be of importance. For instance, a pedestrian in low-contrast shadows is more critical than a shadowy corner of a building.

In some embodiments, the ACD system outputs modified alt-text that highlights the objects and features in low-contrast regions. In some embodiments, the ACD system avoids redundancy by outputting alt-text that focuses on critical regions for understanding the images content. For example, as shown in the illustrative example, the modified alt-text “a young girl stands beside a large Skyfall movie poster. She has a scared expression and recoils from a gun on the poster pointed at her” replaces the original alt-text, which highlights the otherwise hard to identify objects with a visual impairment corresponding to contrast insensitivity.

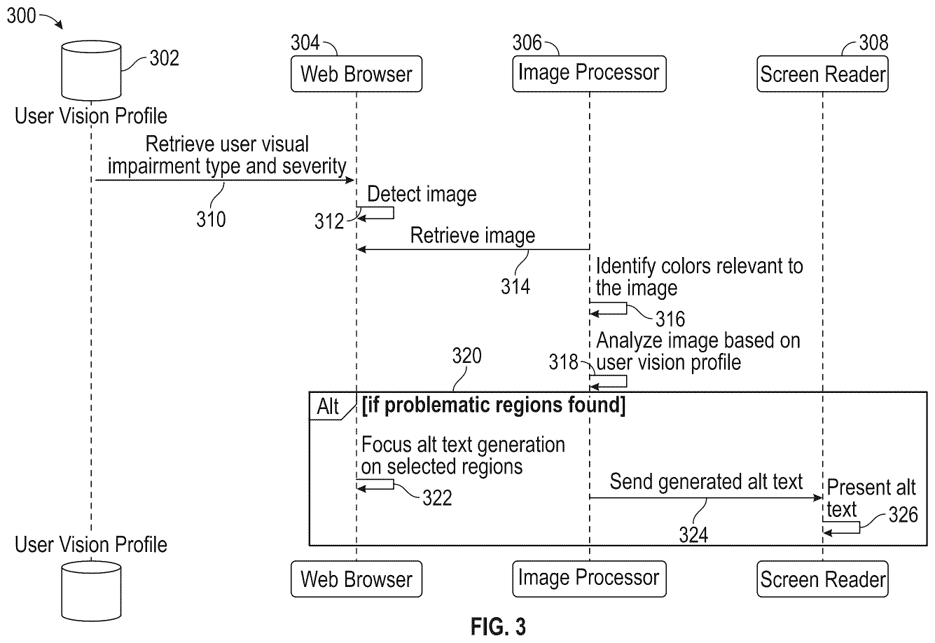

FIG. 3 shows an illustrative sequence diagram for creating tailored descriptions of content based on a visual impairment, in accordance with some embodiments of this disclosure. The processes of FIG. 3 are implemented, for instance, by the ACD system 100 of FIGS. 1 and/or 200 of FIG. 2.

In some embodiments, a web browser 304, at 310, requests or retrieves data corresponding to a visual impairment type and severity from a vision profile 302 associated with a computing device (e.g., computing device 101 of FIG. 1 and/or computing device 201 of FIG. 2). In some embodiments, a computing device is logged into using the credentials of an account corresponding to the computing device and/or the credentials corresponding to, for example, an application, service provider, webpage, etc. In some embodiments, the credentials used to log-in to the computing device, application, service provider, webpage, etc. correspond to a vision profile. In some embodiments, the vision profile corresponds to data indicating a visual impairment (e.g., a colorblindness visual impairment, a contrast insensitivity visual impairment, a blurred vision visual impairment, etc.). In some embodiments, data indicating a visual impairment within the vision profile corresponds to a type of visual impairment, a severity of the visual impairment, etc.

In some embodiments, the web browser 304 detects or receives, at 312, an image from a website (e.g., the web browser may load, request, receives, or fetches HTML from a website). In some embodiments, an image processor 306 retrieves from the web browser 304 the image (see 314). In some embodiments, the image processor 306 retrieves the image from the web browser 304, for example, by accessing HTML <img> tags. In some embodiments the image processor 306 retrieves the image from the web browser 304 by using an API to download the image (e.g., Fetch API). In some embodiments, the web browser 304 downloads the file pointed by an src attribute and sends it to the image processor 306 to retrieve the image. In another example, the web browser 304 provides a URL of the image file to the image processor 306, which may be used to retrieve the image.

As shown in FIG. 3, image processor 306, at 316, analyzes the images and/or metadata associated with the image, and identifies the colors that are relevant to the image. In some embodiments, image processor 306 analyzes the image, at 318, based on the vision profile associated with the computing device. In some embodiments, the image processor 306, as a part of process 318, generates a simulated image based on the visual impairment type. The image processor 306 may further, as a part of process 318, generate the simulated imaged based on visual impairment severity. For example, in relation to a visual impairment type identified as protanopia (i.e., a red-green color blindness), the image processor 306 transforms the color representation of the image into a perceptually uniform color space (e.g., CIE Lab or LMS color space) by separating luminance from chromatic information. According to this example, the image is further modified with a customized colorblindness simulation matrix, specific to the type of identified colorblindness, to reflect how the image is perceived based on the identified visual impairment. In another example, for a visual impairment type identified as a contrast insensitivity visual impairment, the image processor may covert the image into a luminance-based color space (e.g., CIE Lab or YUV color space), where the luminance channel separates brightness from chromatic information. Further, according to this example, using the luminance channel, a pixel level brightness gradient is calculated, and regions of low contrast are highlighted by measuring changes in intensity across neighboring pixels.

In one example, where the visual impairment type is identified as a color blindness, a comparative analysis between the original image and the simulated image is performed by the image processor 306. In some embodiments, the image processor 306 may calculate color differences using metrics such as Delta E (CIEDE2000), which quantifies the difference between two colors as perceived by the human eye. In some embodiments, high Delta E values indicate areas of the image where color differences are significant in the original image and these regions are flagged as visually challenging. In some embodiments, where the visual impairment type is identified as protanopia color blindness for example, image processor 306 identifies and localizes objects in the image by using object detection models. In some embodiments, using the object detection models, image processor 306 draws bounding boxes or segmentation masks around the objects. In some embodiments, for each detected object, image processor 306 performs a localized color analysis, assessing the color variations within the object and the impact of the color blindness visual impairment.

In another example, where the visual impairment type is identified as contrast insensitivity, image processor 306 may apply a saliency detection algorithm that considers luminance differences. In some embodiments, the image processor 306 uses saliency models (e.g., DeepGaze or GBVS) to predict regions of importance of an image based on brightness and edge information. In some embodiments, these saliency models are modified to focus on areas identified with low contrast. In some embodiments, the image processor 306, generates a heatmap to visualize regions with insufficient tonal separation, marking these regions as visually challenging for a visual impairment identified as contrast insensitivity. In some embodiments, once the low-contrast areas are identified, image processor 306 applies object detection models (e.g., Mask R-CNN or Faster R-CNN), to locate objects within low-contrast regions. In some embodiments where object boundaries are blurred due to insufficient contrast, edge detection algorithms (e.g., Canny Edge Detection) are applied to refine object segmentation.

In some embodiments, if at 320 one or more problematic regions are found (e.g., the regions have been marked as visually challenging for the specific visual impairment), the web browser 304 focuses the alt-text generation or determination on the problematic region(s) (see 322). In one example, where the visual impairment type is identified as a color blindness, the web browser 304 synthesizes the results from the object detection, colorblind simulation, and saliency analysis stages to generate tailored descriptions of the image focusing on the regions marked as visually challenging for the visual impairment identified as a color blindness visual impairment type. For example, instead of generating a generic description such as “an apple and leaves in a garden,” the web browser 304, for example, generates “a red apple with green leaves in a garden,” to focus on the perceptually relevant part of the image specific to the visual challenges associated with the visual impairment type.

In another example, where the visual impairment type is identified as a contrast insensitivity visual impairment type, the web browser 304 generates alt-text that focuses on the identified objects and features in the low-contrast regions. For example, instead of a generic description such as “a parking lot with cars,” the web browser 304 generates “a dark car in a shadowed area at the center of the parking lot, blending into the asphalt,” which focuses on the perceptually relevant part of the image specific to the visual challenges associated with the visual impairment type.

In some embodiments, the image processor 306, at 324, sends the generated tailored alt-text 324 to a screen reader 308. In some embodiments, the screen reader 308 presents the alt-text (see 326). In some embodiments, the screen reader 308 checks for an alt attribute associated with the image. In some embodiments, in response to the alt attribute being present, the screen reader 308 will read the alt description aloud. In some embodiments, the screen reader 308 will read the text aloud by converting the on-screen text into speech using, for example, text-to-speech (“TTS”) technology. In some embodiments, the screen reader 308 may be used in conjunction with braille displays. In some embodiments, the alt-text is displayed simultaneously with the image on a computing device while the screen reader 308 reads the alt-text aloud. In some embodiments, the alt-text is not displayed with the image and the screen reader 308 reads the alt-text associated with the image aloud.

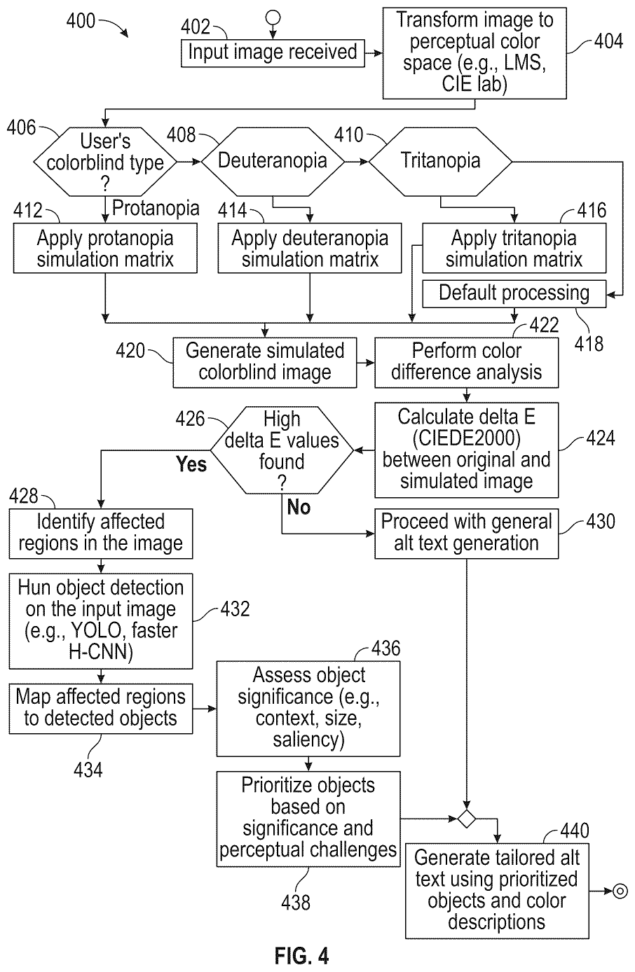

FIG. 4 shows an illustrative sequence diagram for creating tailored descriptions of content based on a visual impairment corresponding to a color blindness visual impairment 400, in accordance with some embodiments of this disclosure. FIG. 4, in some embodiments is implemented by the ACD system 100 of FIGS. 1 and/or 200 of FIG. 2.

In some embodiments, at 402, the ACD system receives an image (e.g., image 102 of FIG. 1). In some embodiments, the ACD system transforms the color representation of the image into a perceptually uniform color space, at 404, for example the CIE Lab or LMS color space. In some embodiments, the ACD system transforms the image color representation into a perceptually uniform color space by separating luminance from chromatic information.

In some embodiments, the ACD system further modifies the image with a color blindness simulation matrix. In some embodiments, the color blindness simulation matrix is customized for each type of colorblindness (e.g., protanopia, deuteranopia, and tritanopia colorblindness). In some embodiments, the ACD system identifies the type of colorblindness corresponding to a computing device or a user of the computing device (see 406). For example, the ACD system identifies a protanopia colorblind type (see 406), a deuteranopia colorblind type (see 408), or a tritanopia colorblind type (see 410) associated with a computing device. In some embodiments, the color blindness simulation matrix modifies the color channels to reflect how the image is perceived based on the type of color blindness. For example, for a color blindness type identified as protanopia, the ACD system applies a protanopia simulation matrix (at 412) which reduces or removes the sensitivity to red light, altering the colors in the image to simulate how red hues blend into greens or grays. In another example, for a color blindness type identified as deuteranopia the ACD system applies a deuteranopia simulation matrix (at 414). In yet another example, for a color blindness type identified as tritanopia the ACD system applies a tritanopia simulation matrix (at 416). In some embodiments, the type of color blindness may not be identified and default processing (at 418) is applied to the image to adjust how the colors are perceived.

In some embodiments, the ACD system, at 420, generates a simulated image based on the type of colorblindness (e.g., simulated image 114 of FIG. 1). In some embodiments, the ACD system at step 422 performs a comparative analysis between the original image and the simulated image. For example, the ACD system, at step 424, may calculate color differences using metrics such as Delta E (CIEDE2000) which quantifies the difference between two colors. In some embodiments, the ACD system determines if high Delta E values were identified (see 426). In some embodiments, high Delta E values indicate areas of the image where color differences are significant. In some embodiments, if high Delta E values are found, the ACD system, at 428, identifies affected regions in the original image. In some embodiments, the ACD system flags high Delta E values in the original image as visually challenging. In some embodiments, if no high Delta E values are found in the original image, the ACD system proceeds with the generic or default description generation (see 430) which does not modify or customize a description based on an identified visual impairment.

In some embodiments, the ACD system integrates advanced object detection models (e.g., Faster R-CNN or YOLO) to identify and localize objects in the original image (see 432), by for example, drawing boundary boxes or segmentation masks around the objects. In some embodiments, for each object detected the ACD system, at 434, performs a localized color analysis, assessing the color variations within the object and the impact of the colorblindness type on those variations. For example, in an image with a scene with a red apple and green leaves, the ACD system detects each of these objects separately and evaluates how the apple's red color and the green leaves are perceived by a colorblindness type of protanopia. If the ACD system determines that the apple and the leaves appear similar in the colorblind simulation, the ACD system recognizes this as a critical issue and prioritizes the apple in the alternative description.

In some embodiments, the ACD system uses a saliency detection model (see 436) to assess an object identified within the original image significance. In some embodiments, the saliency detection model predicts which regions of an image are likely to be of significance based on features like color, texture, and spatial layout. In some embodiments, the ACD system, at 438, cross references saliency maps with the color analysis results. For example, in an image with a traffic scene, a red stoplight that blends into the background due to a protanopia colorblindness type would be flagged as critical, even if it occupies a relatively small area in the image.

In some embodiments, the ACD system, at 440, tailors the description (e.g., alt-text) of the image based on the prioritized objects and associated color descriptions. For example, the ACD system may us a natural language generation (NLG) system to generate the tailored descriptions for the image. In some embodiments, the ACD system synthesizes the results of the object detection, colorblind simulation, and saliency analysis to create a concise and specific description based on the specific identified colorblindness type. For example, for an image displaying an apple in a garden, instead of generating a generic description such as “an apple and leaves in a garden,” the ACD system would generate “a red apple with green leaves,” reflecting the challenging part of the scene with an identified colorblindness type of protanopia.

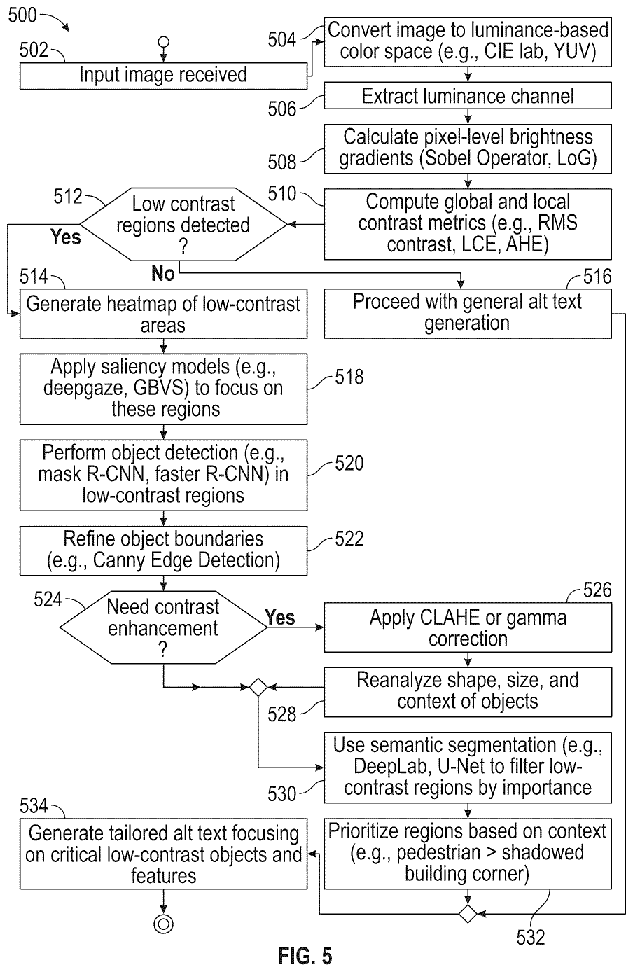

FIG. 5 shows an illustrative sequence diagram for creating tailored descriptions of content based on a visual impairment corresponding to a contrast insensitivity visual impairment 500, in accordance with some embodiments of this disclosure. FIG. 5, in some embodiments is implemented by the ACD system 200 of FIG. 2.

In some embodiments the ACD system, at step 502, receives an image (e.g., image 202 of FIG. 2). In some embodiments, the ACD system converts the image into a luminance-based color space (see 504), such as CIE Lab or YUV color space. In some embodiments the ACD system, at 506, converts the image into a luminance-based color space by separating brightness from chromatic information to identify tonal differences in the image. In some embodiments, using the extracted luminance channel, the ACD system calculates a pixel-level brightness gradient (see 508). For example, the ACD system uses models such as Sobel operator or Laplacian of Gaussian (“LoG”), which measure changes in intensity across neighboring pixels in an image. In some embodiments, global and local contrast metrics are computed (see 510). For example, metrics such as root mean square (“RMS”) contrast are calculated to assess the overall tonal range of the image. In another example, techniques such as Local Contrast Enhancement (“LCE”) or Adaptive Histogram Equalization (“AHE”) are employed to detect and amplify contrast variations within smaller, located regions in the image.

In some embodiments, the ACD system, at process 512, determines if low contrast regions are detected based on the calculated pixel-level brightness gradients at 508 and the computed global and local contrast metrics at 510. In some embodiments, if no low contrast regions are detected, the ACD system, at 516, proceeds with generating a generic description of the image, which is not tailored to an identified visual impairment.

In some embodiments, if low contrast areas are detected, the ACD system generates a heatmap of low-contrast areas (see 514). In some embodiments, the ACD system applies a saliency detection model to focus on the detected luminance differences (see 518). For example, the ACD system can utilize saliency models such as DeepGaze or Graph-Based Visual Saliency (“GBVS”) to predict regions that are of importance in an image based on brightness and edge information. For example, in an image portraying a landscape, the ACD system may flag areas where distant hills blend into the sky due to poor contrast or where objects in shadows lack tonal definition.

In some embodiments, the ACD system applies object detection algorithms (e.g., Mask R-CNN or Faster R-CNN) to locate objects within the identified low-contrast regions (see 520). In some embodiments, objects partially or fully obscured by low contrast are prioritized for the tailored description. For example, a car in a shadowy part of a parking low would be detected and flagged as critical for the generation of the tailored description for a visual impairment identified as contrast insensitivity.

In some embodiments, the ACD system, at 522, refines object segmentation where object boundaries are blurred due to insufficient contrast. For example, edge-detection models such as Canny Edge Detection may be applied. In some embodiments, the ACD system, at step 524, determines if contrast enhancement is required to analyze and describe objects in low contrast regions. In some embodiments, if the ACD system determines that contrast enhancement is not required, the ACD system, at 530, proceeds to using semantic segmentation to filter low-contrast regions by importance. In some embodiments, if the ACD system determines that contrast enhancement is required, the ACD system proceeds to apply a model to enhance contrast in specific regions without over-sampling noise (see 526), for example, Contrast Limited Adaptive Histogram Equalization (“CLAHE”) or Gamma Correction. In some embodiments, the model used to enhance contrast in specific regions, such as Gamma Correction to adjust brightness levels to make dark areas more distinguishable, allow the ACD system to better analyze the shape, size, and context of objects in low-contrast regions (see 528).

In some embodiments, since not all low-contrast regions are equally important, the ACD system, at 530, filters regions based on their contextual importance using sematic segmentation models (e.g., DeepLab or U-Net) to segment the image into important regions (e.g., sky, ground, building, objects). In some embodiments, the ACD system, at 532, prioritizes the regions based on the context of the image (e.g., a pedestrian is prioritized over a shadowed building corner).

In some embodiments using the results from the previous steps discussed above, the ACD system generates a tailored description of the image focusing on the objects and features in low contrast regions (see 534). In some embodiments, the tailored description avoids redundancy by focusing only on regions of critical importance for understanding the context of the image. For example, instead of a generic description such as “a parking lot with cars, the ACD system may generate, “a dark car in a shadowed area at the center of the parking lot, blending into the asphalt,” for a visual impairment of contrast insensitivity. In some embodiments, the generated tailored description highlights the otherwise hard-to-identify objects.

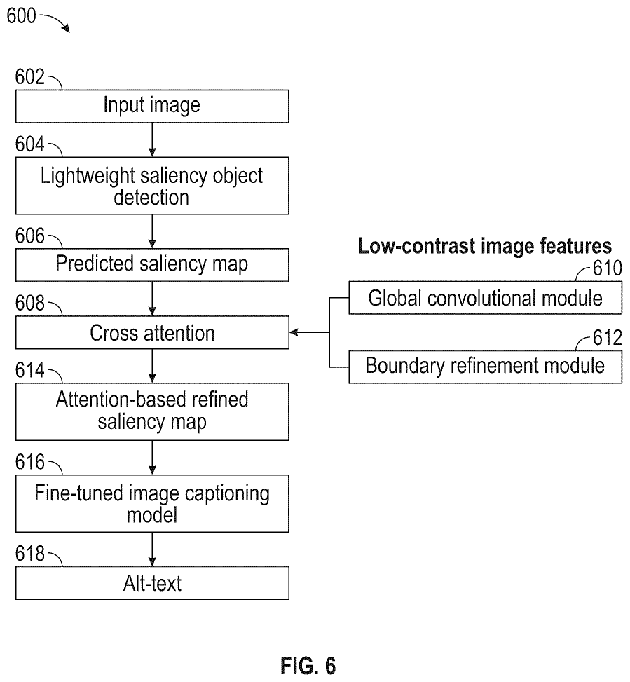

FIG. 6 shows an illustrative sequence diagram for utilizing saliency prediction networks to generate tailored descriptions of content 600, in accordance with some embodiments of this disclosure. FIG. 6, in some embodiments is implemented by the ACD system 100 of FIG. 1 and 200 of FIG. 2.

In some embodiments, the ACD system, at step 602, receives an image (e.g., image 102 of FIG. 1 or image 202 of FIG. 2). In some embodiments, the ACD system, at step 604, applies a lightweight saliency object detection model to the image to specific objects or regions that are visually prominent within the image. In some embodiments, a saliency object detection model detects key objects in real-time to identify and classify objects or features.

In some embodiments, the ACD system utilizes a predicted saliency map (see 606) to indicate which regions of the image are most likely to attract attention. In some embodiments, high-contrast areas represent regions of higher attention. In some embodiments, the predicted saliency map focuses on features such as color contrast, edges, and texture to predict which areas are most likely to draw attention.

In some embodiments, the ACD system uses global convolutional module (at 610) to perform convolution across the entire image to capture contextual information rather than just local features. In some embodiments, the ACD system, at 612, uses a boundary refinement module to enhance the accuracy of object boundaries and refine object segmentation. In some embodiments, global feature maps and local feature maps are extracted using global convolutional module (at 610) and boundary refinement module (at 612) and combined with the predicted saliency map (at 606) for cross attention (at 608).

In some embodiments, the ACD system combines the global features (at 610) and local features (at 612) into a combined feature map using techniques such as element-wise addition, weighted sum, or concatenation. For example, using the weighted sum technique, and example equation such as the one below may be used:

$${F}_{global \_ local} = {w}_{g} \cdot {F}_{global} + w \cdot {F}_{local}$$

In some embodiments, the ACD system uses an attention mechanism to use fused global and local features as a guide to refine the predicted saliency map (at 614), at cross attention 608, using an equation such as, for example:
Query (Q): Derived from the original saliency map (P).
Key (K) and Value (V): Derived from the fused global 610-local 612 features (F_{global_local})

$$Attention weights = Soft Max ( \frac{{QK}^{T}}{\sqrt{{d}_{k}}} )$$

In some embodiments, the ACD system refines the original saliency map (at 614) using the above attention weights. An example equation to refine the original saliency map is below:

$${P}_{refined} = Attention weights * P$$

In some embodiments, the results of the attention-based saliency map are input into the fine-tuned image captioning model (at 616). In some embodiments, the ACD system uses the image captioning architecture guided by the refined saliency maps to generate a fine-tuned image captioning model.

In some embodiments, the ACD system generates alt-text (see 618) using the results of the fine-tuned image captioning model as input. In some embodiments, the alt-text, at step 618, is generated using low-contrast image feature maps (see 610 and 612) and multi-scale lightweight saliency prediction networks (see 604 and 606).

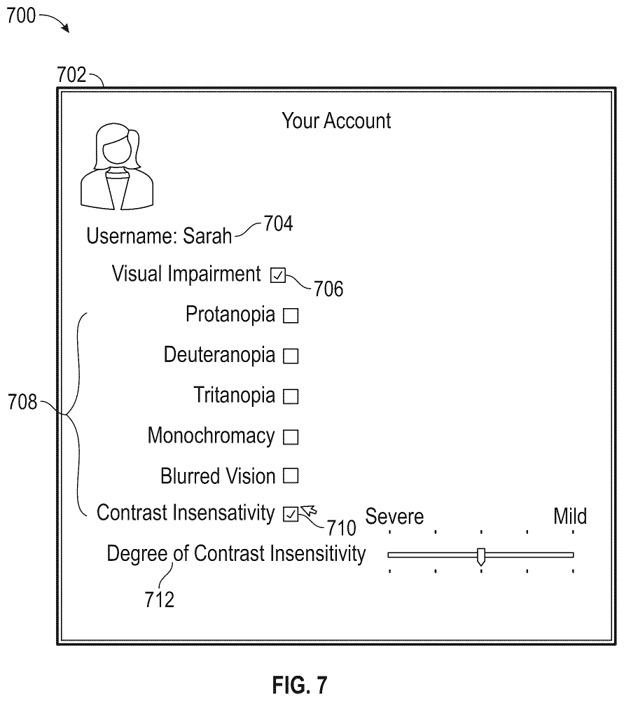

FIG. 7 shows an illustrative example of a graphical interface to manage a visual impairment corresponding to a computing device 700, in accordance with some embodiments of this disclosure. FIG. 7, in some embodiments is implemented by the ACD system 100 of FIG. 1 and 200 of FIG. 2.

In some embodiments, the graphical interface 700 is output at a computing device (e.g., computing device 101 of FIG. 1) logged into using the credentials of an account 702 corresponding to the computing device and/or the credentials corresponding to, for example, an application, service provider, webpage, etc. The graphical interface 700 outputs settings associated with the credentials corresponding to the computing device 704 (e.g., the username Sarah) such as information regarding a visual impairment 706. In some embodiments, the ACD system may output settings that are different based on the visual impairment. For example, as shown in this illustrative example, based on the contrast insensitivity visual impairment being selected 710, a degree of contrast insensitivity 712 is generated for selection.

In this illustrative example, graphical interface 700 is output at a computing device 702, displaying the settings associated with Sarah's account. According to this example, Sarah's account is logged into using credentials associated with an account corresponding to a username Sarah 704. In some embodiments, according to this illustrative example, Sarah's account information, corresponds to a visual impairment 706. In some embodiments, in response to a user interface input selecting the visual impairment option 706, a menu (e.g., a drop-down menu) may be generated for additional user interface input to be received to select which specific visual impairment 708 is associated with the account 704 corresponding to the computing device 702. In some embodiments, the computing device 702 may receive a user interface input 710, selecting a specific visual impairment associated with the computing device 702. As shown in this illustrative example, computing device 702 receives a user interface input selecting the contrast insensitivity 710 visual impairment from a list of selectable visual impairments 708 (e.g., protanopia, deuteranopia, tritanopia, monochromacy, blurred vision, or contrast insensitivity).

In some embodiments, in response to receiving the user interface input selecting the contrast insensitivity visual impairment 710, a degree of contrast insensitivity is generated for further user interface input 712. In some embodiments, a slide bar generated for user interface input to identify the degree of the visual impairment 712 associated with the account 704 corresponding to the computing device 702. It should be understood that this graphical interface 700 is shown for illustrative purposes and the graphical interface 700 may provide any setting necessary for a computing device associated with an account with an identified visual impairment to generate tailored descriptions based on the associated visual impairment.

FIGS. 8-9 show illustrative devices, systems, servers, and related hardware for generating a multi-layer image, in accordance with some embodiments of this disclosure. 10 FIG. 8 is a diagram of an illustrative system 800, in accordance with some embodiments of this disclosure. Computing devices 807, 808, 810 (which may correspond to, e.g., computing device 900 or 901 of FIG. 9) may be coupled to communication network 809. Communication network 809 may be one or more networks including the Internet, a mobile phone network, mobile voice or data network (e.g., a 5G, 4G, or LTE network), cable 15 network, public switched telephone network, or other types of communication network or combinations of communication networks. Paths (e.g., depicted as arrows connecting the respective devices to the communication network 809) may separately or together include one or more communications paths, such as a satellite path, a fiber-optic path, a cable path, a path that supports Internet communications (e.g., IPTV), free-space connections (e.g., for 20 broadcast or other wireless signals), or any other suitable wired or wireless communications path or combination of such paths. Communications with the client devices may be provided by one or more of these communications paths but are shown as a single path in FIG. 8 to avoid overcomplicating the drawing.

Although communications paths are not drawn between computing devices, these 25 devices may communicate directly with each other via communications paths as well as other short-range, point-to-point communications paths, such as USB cables, IEEE 1394 cables, wireless paths (e.g., Bluetooth, infrared, IEEE 302-11x, etc.), or other short-range communication via wired or wireless paths. The computing devices may also communicate with each other directly through an indirect path via communication network 809. 30

System 800 may comprise media content source 802, one or more servers 804, and/or one or more edge computing devices. In some embodiments, system or application (e.g., ACD application) may be executed at one or more of control circuitry 811 of server 804 (and/or control circuitry of computing devices 807, 808, 810 and/or control circuitry of one or more edge computing devices). In some embodiments, the media content source and/or server 804 may be configured to host or otherwise facilitate video communication sessions between computing devices 807, 808, 810 and/or any other suitable computing devices, and/or host or otherwise be in communication (e.g., over network 809) with one or more social network services.

In some embodiments, server 804 may include control circuitry 811 and storage 814 (e.g., RAM, ROM, Hard Disk, Removable Disk, etc.). Storage 814 may store one or more databases. Storage 814 may store in a non-transitory memory, instructions for the CD application. Server 804 may also include an input/output path 812. I/O path 812 may include or correspond to input circuitry and/or output circuitry. I/O path 812 may be used to send and 10 receive commands, requests, and other suitable data. I/O path 812 may provide content (e.g., content items), machine learning model inputs and/or outputs, device information, or other data, over a local area network (LAN) or wide area network (WAN), and/or other content and data to control circuitry 811, which may include processing circuitry, and storage 814. Control circuitry 811 may be used to send and receive commands, requests, and other suitable 15 data using I/O path 812, which may comprise I/O circuitry. I/O path 812 may connect control circuitry 811 (and specifically control circuitry) to one or more communications paths. I/O path 812 may consist of circuitry that facilities the transfer of data between components within the system.

Control circuitry 811 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 811 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 811 executes instructions for an emulation system application stored in memory (e.g., the storage 814). Memory may be an electronic storage device provided as storage 814 that is part of control circuitry 811.

FIG. 9 shows generalized embodiments of illustrative computing devices 900 and 901, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any—31—other suitable computing device; or any combination thereof. In another example, computing device 901 may be a user television equipment system or device.

User television equipment device 901 may include set-top box 915. Set-top box 915 may be communicatively connected to microphone 916, Audio output equipment (e.g., 5 speaker or headphones 914), and display 912. In some embodiments, microphone 916 may receive audio corresponding to a voice of a user providing input. In some embodiments, display 912 may be a television display or a computer display. In some embodiments, set-top box 915 may be communicatively connected to user input interface 910. In some embodiments, user input interface 910 may be a remote control device. Set-top box 915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 8. In some embodiments, computing device 900 may comprise any suitable number of 15 sensors (e.g., gyroscope or accelerometer, etc.), and/or a GPS module (e.g., in communication with one or more servers and/or cell towers and/or satellites) to ascertain a position of computing device 900. In some embodiments, computing device 900 comprises a rechargeable battery that is configured to provide power to the components of the device.

Each one of computing device 900 and computing device 901 may receive content 20 and data via input/output (I/O) path 902. I/O path 902 may provide content (e.g., broadcast programming, on-demand programming, Internet content, content available over a local area network (LAN) or wide area network (WAN), and/or other content) and data to control circuitry 904, which may comprise processing circuitry 906 and storage 908. Control circuitry 904 may be used to send and receive commands, requests, and other suitable data 25 using I/O path 902, which may comprise I/O circuitry. I/O path 902 may connect control circuitry 904 (and specifically processing circuitry 906) to one or more communications paths (described below). I/O functions may be provided by one or more of these communications paths, but are shown as a single path in FIG. 8 to avoid overcomplicating the drawing. While set-top box 915 is shown in FIG. 9 for illustration, any suitable computing device having 30 processing circuitry, control circuitry, and storage may be used in accordance with the present disclosure. For example, set-top box 915 may be replaced by, or complemented by, a personal computer (e.g., a notebook, a laptop, a desktop), a smartphone (e.g., computing device 900), an XR device; a tablet; a network-based server hosting a user-accessible client device; a non-user-owned device; any other suitable device; or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an 10 Intel Core i7 processor). In some embodiments, control circuitry 904 executes instructions for the system or application stored in memory (e.g., storage 908). Specifically, control circuitry 904 may be instructed by the system or application to perform the functions discussed above and below. In some implementations, processing or actions performed by control circuitry 904 may be based on instructions received from the system or application.

In client/server-based embodiments, control circuitry 904 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 908, and executed by control circuitry 904 of a computing device 900.

In some embodiments, the system or application may be a client/server application where only the client application resides on device 900 (e.g., computing device 102), and a server application resides on an external server (e.g., server 804). For example, the system or application may be implemented partially as a client application on control circuitry 904 of device 900 and partially on server 804 as a server application running on control circuitry 811. Server 804 may be a part of a local area network with one or more of computing 30 devices 900, 901 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 804 and/or an edge computing device), referred to as “the cloud.” Device 900 may be a cloud client that relies on the cloud computing capabilities from server 804 to determine whether processing should be offloaded from the mobile device, and facilitate such offloading. When executed by control circuitry of server 804, the system or application may instruct control circuitry 811 to perform processing tasks for the client device and facilitate the analysis of content items. The client application may instruct control circuitry 904 to determine whether processing should be offloaded.

Control circuitry 904 may include communications circuitry suitable for communicating with a server, edge computing systems and devices, a table or database 10 server, or other networks or servers The instructions for carrying out the above-mentioned functionality may be stored on a server (which is described in more detail in connection with FIG. 8. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 8). In addition, communications circuitry may include circuitry that enables peer-to-peer communication of computing devices, or communication of computing devices in positions remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as the system or application data described above. Storage 908 may store in non-transitory memory instructions for CD application. Nonvolatile memory may also be used (e.g., to launch a boot-up routine and other instructions). Cloudbased storage, described in more detail in relation to FIG. 8, may be used to supplement storage 908 or instead of storage 908.

Control circuitry 904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 904 may also include scaler circuitry for upconverting and downconverting content into the preferred output format of computing device 900. Control circuitry 904 may also include digital-to-analog converter circuitry and analog-to-digital converter circuitry for converting between digital and analog signals. The tuning and encoding circuitry may be used by computing device 900, 901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from computing device 900, the tuning encoding circuitry (including multiple tuners) may be associated with storage 908.

Control circuitry 904 may receive instruction from a user by way of user input interface 910. User input interface 910 may be any suitable user interface, such as a remote control, mouse, trackball, keypad, keyboard, touch screen, touchpad, stylus input, joystick, voice recognition interface, or other user input interfaces. Display 912 may be provided as a stand-alone device or integrated with other elements of each one of computing device 900 and computing device 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to set-top box 915.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of computing device 900 and computing device 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters, words, terms, or numbers that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card.

The system or application may be implemented using any suitable architecture. For example, it may be a stand-alone application wholly-implemented on each one of computing device 900 and computing device 901. In such an approach, instructions of the application may be stored locally (e.g., in storage 908), and data for use by the application is downloaded on a periodic basis (e.g., from an out-of-band feed, from an Internet resource, or using another suitable approach). Control circuitry 904 may retrieve instructions of the application from storage 908 and process the instructions to provide the functionality, and generate any of the displays, discussed herein. Based on the processed instructions, control circuitry 904—may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, historical interactions by the user, and/or any other suitable data. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the system or application is a client/server-based application. Data for use by a thick or thin client implemented on each one of computing device 900 and computing device 901 may be retrieved on-demand by issuing requests to a server remote to each one of computing device 900 and computing device 901. For example, the remote server may store the instructions for the application in a storage device. The remote server may process the stored instructions using circuitry (e.g., control circuitry 904) and generate the displays discussed above and below. The client device may receive the displays generated by the remote server and may display the content of the displays locally on computing device 900. This way, the processing of the instructions is performed remotely by the server while the resulting displays (e.g., that may include text, a keyboard, or other visuals) are provided locally on computing device 900. Computing device 900 may receive inputs from the user via input interface 910 and transmit those inputs to the remote server for processing and generating the corresponding displays. For example, computing device 900 may transmit a communication to the remote server indicating that an up/down button was selected via input interface 910. The remote server may process instructions in accordance with that input and generate a display of the application corresponding to the input (e.g., a display that moves a cursor up/down). The generated display is then transmitted to computing device 900 for presentation to the user.

In some embodiments, the system or application may be downloaded and interpreted or otherwise run by an interpreter or virtual machine (run by control circuitry 904). In some embodiments, system or application may be encoded in the ETV Binary Interchange Format (EBIF), received by control circuitry 904 as part of a suitable feed, and interpreted by a user agent running on control circuitry 904. For example, the system or application may be an EBIF application. In some embodiments, the system or application may be defined by a series of JAVA-based files that are received and run by a local virtual machine or other suitable middleware executed by control circuitry 904. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

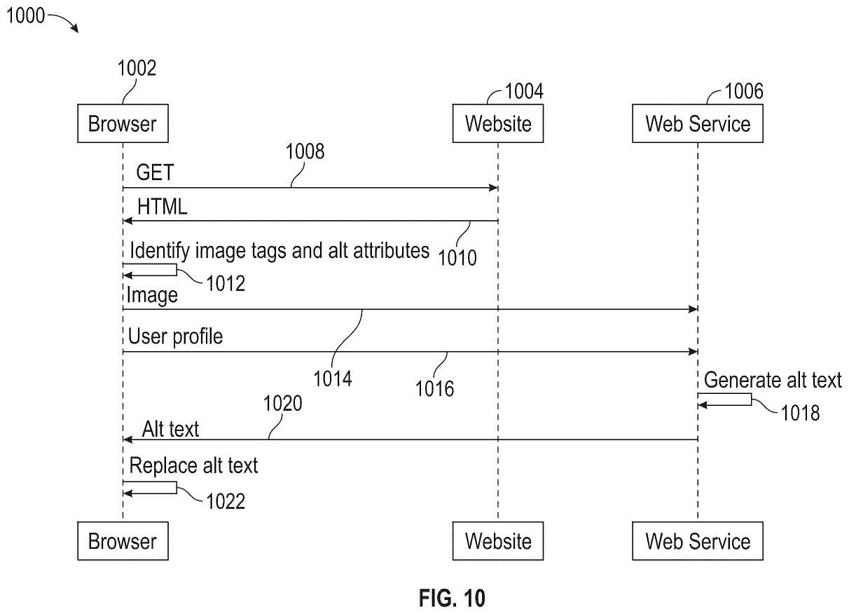

FIG. 10 shows an illustrative sequence diagram for a web browser including dynamic tailored description generation for content based on a visual impairment, in accordance with some embodiments of this disclosure. FIG. 10, in some embodiments is implemented by the ACD system 100 of FIG. 1 and 200 of FIG. 2.

In some embodiments, an account may be logged into using the credentials associated with the account, and the account may be associated with an accessibility profile indicating that a vision deficiency is associated with the accessibility profile. In some embodiments, a web browser 1002 sends a request, for example a GET request 1008, to a website 1004 to retrieve data (e.g., HTML pages, image, scripts, etc.). In some embodiments, in response to the GET request (see 1008) from the browser 1002, the website 1004 responds with an HTML document (see 1010) that includes alt-texts, pages, images, and/or scripts, etc., in the form of the “alt” attribute. In some embodiments, the browser 1002, upon receiving the requested information or content that includes alt-texts, pages, images, and/or scripts, etc., identifies, at 1012, the image tags and alt attributes. For example, when the browser 1002 loads the webpage, it reads the HTML content (see 1010) and processes it element by element. In some embodiments, the browser 1002 identifies the <img> tag within with HTML document and then processes the tag's attributes, such as src (source of the image), alt (alternative text), width, height, and other attributes. In some embodiments, the alt attribute is part of the <img> tag, and its purpose is to provide a text description of the image. In some embodiments, the browser 1002 checks for the presence of the alt attribute to improve accessibility. For example, the browser 1002 may identify an alt attribute and store it for use in situations where the image cannot be displayed (e.g., if the image fails to load, or it the user relies on a screen reader). As an example, the browser 1002 may receive the following HTML section from the website 1004:
<img sr=“img_girl.jpg” alt=“Girl in a jacket” width=“500” height=“600”>

In some embodiments, upon receiving a webpage that includes alt-texts in the form of alt attribute, the browser 1002 may use an API or another form of web service 1006 to generate or otherwise identify a replacement alt-text. In some embodiments, the computing device is associated with a profile that specifies a visual impairment. In some embodiments, the browser has access to the profile information through a browser extension or user settings. In some embodiments, the browser 1002 may send a request to a web service 1006 to analyze the image and generate a tailored description of the image based on the visual impairment. In some embodiments, the browser 1002 sends the image (see 1014), or alternatively, the browser 1002 may send the image's URL to the web service 1006. In some embodiments, the browser 1002 also sends to the web service 1006, the information associated with the user profile (see 1016), which includes the visual impairment qualifier, so that the web service 1006 may tailor the alt-text generation to the specific visual impairment.

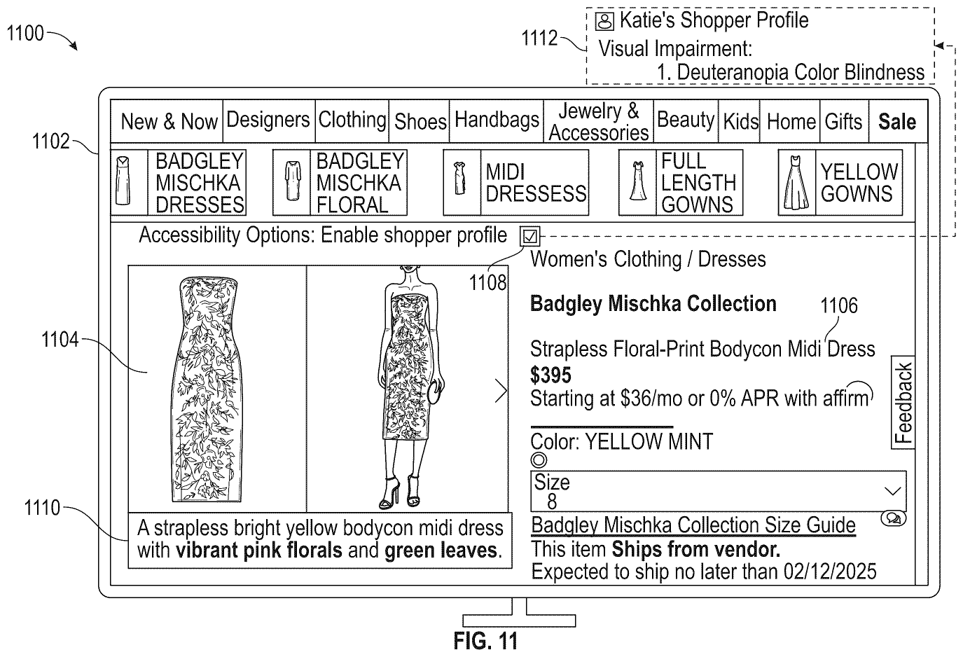

In some embodiments, the web service 1006 uses machine learning models or image recognition APIs to generate an alt-text of the image (see 1018). For example, the web service 1006 may use machine learning models to identify objects, people, scenes, and other relevant details and based on the visual impairment qualifier corresponding to the user profile 1016, the web service 1006 may adjust the level of detail in the alt-text. In some embodiments, the web service 1006 uses the methods as described in earlier sections of this specification in conjunction with FIGS. 1-9 as well as FIGS. 11-13 to generate an alt-text of the image 1018.

In some embodiments, the web service 1006 returns the modified alt-text, at 1020, to the browser 1002. In some embodiments, the modified alt-text replaces the alt attribute value of the original HTML section (see 1022). Continuing with the above example of HTML section, the web service 1006 may return “Girl with red hair in a purple jacket”. In some embodiments, the browser 1002 would update the HTML section as follows:

<img src=“img_girl.jpg” alt=“Girl with red hair in a purple jacket”
width=“500” height=“600”>

In some embodiments, when the browser 1002 receives the modified alt-text 1020 from the web service 1006, the browser 1002 dynamically replaces the existing alt attribute of the image tag, so that the screen reader automatically outputs the new description to the user, just as it would for any other webpage with properly defined alt-text. In some embodiments, the change to the alt-text is transparent since it is handled automatically by the browser and does not require any manual action or disruption to the experience. In some embodiments, the screen reading capability is built into the browser 1002. In some embodiments, the screen reading capability is not built into the browser 1002 but is integrated through a browser extension. In some embodiments, since the replacement of the original alt-text with the modified alt-text occurs before the browser starts rending the page (i.e., prior to the document ready event), the data fed into the browser extension is the modified data and contains the accessible alt-text.

In some embodiments, the browser 1002 may only send a request for modified alt-text for the image based on a visual impairment qualifier to the web service 1006 if the image already has existing alt-text (i.e., the alt attribute contains a non-empty value). In some embodiments, this may limit the amount of data that needs to be altered and be more efficient on the web service 1006. In some embodiments, by requesting modified alt-text only for image that already have an alt attribute, the web service 1006 avoids redundant requests for image that do not need new alt-text, helps to avoid unnecessary bandwidth usage by the web service 1006, and the web service 1006 focuses on modifications where required (e.g., enhancing alt-text for images with inadequate descriptions).

In some embodiments, the browser 1002 may request alt-text from the web service 1006 for all images in the webpage, whether or not an alt attribute is present. In some embodiments, requesting alt-text for all images improves accessibility and consistency of the website 1004 received at the web browser 1002.

In some embodiments, the web service 1006 hashes the pictures or URLs and profile information it receives and caches the associated alt-texts. In some embodiments, when the same picture/URL and profile information is posted, the webservice 1006 checks if it has previously cached the alt-text for that image, and if so, returns the cached alt-text to the browser 1002. In other embodiments, the browser 1002 caches the alt-text locally to reduce the need for repeated requests to the web service 1006. In some embodiments, when the browser 1002 requests alt-text for an image, and the web service 1006 returns the modified alt-text, the browser 1002 will store in local storage using a unique key, such as the image URL or a hash of the image content the modified alt-text associated with the image. In some embodiments, on subsequent page loads, the browser 1002 checks local storage to see if the alt-text for that image already exists. In some embodiments, if found, the modified cached alt-text is retrieved and used to populate the images alt attribute.

FIG. 11 is an illustrative example of a retail webpage implementing a shopper profile to alter descriptions based on a visual impairment 1100, in accordance with some embodiments of this disclosure. FIG. 11, in some embodiments is implemented by the ACD system 100 of FIG. 1 and 200 of FIG. 2.

In some embodiments, the ACD system can use the above embodiments described in detail in FIG. 10 to alter a visible caption on a webpage 1100. For example, a computing device 1102 receives an image via a browser (e.g., browser 1002 of FIG. 10) from a server associated with a retail webpage (e.g., webpage 1004 of FIG. 10). In some embodiments, the retail webpage outputs a short textual description 1106 (e.g., “Strapless Floral-Print Bodycon Midi Dress”) of the product presented in the image 1104.

In some embodiments, the ACD system may output accessibility options that enable the webpage to implement a shopper profile (e.g., specific information relating to a shopper). In some embodiments, the shopper profile corresponds to information indicating a visual impairment. For example, the shopper profile 1112 (e.g., Katie's shopper profile) may indicate a deuteranopia (i.e., a type of color blindness that makes it difficult to distinguish between shares of red and green) visual impairment. In some embodiments, based on the shopper profile 1112, the browser may alter the content of the descriptive text 1106 to make it more relevant for the visually impaired shopper. For example, the browser may request a modified description of the image 1104 based on the shopper profile 1108 corresponding to a visual impairment (e.g., visual impairment qualifier deuteranopia color blindness 1108 associated with Katie's shopper profile).

In some embodiments, the browser may receive from an API or web service (e.g., web service 1006 of FIG. 10) modified alt-text 1110 corresponding to the image 1104 tailored to the visual impairment identified in the shopper profile 1112. For example, the original description of the image 1104 may be replaced with modified alt-text 1110 such as “[a] strapless bright yellow bodycon midi dress with vibrant pink florals and green leaves”. In some embodiments, the browser may output an accessible alt-text consistent with the modified caption in case a screen reader is used when visiting the website. In some embodiments, the modified alt-text 1110 may be overlaid on the image 1104 at the location of what the modified alt-text is describing. For example, the modified alt-text “bright yellow” may be overlaid on a section of the image of the yellow dress and the modified alt-text “pink florals” and “green leaves” would similarly be overlaid on a part of the image where the florals and the leaves are displayed. In some embodiments, the overlay of the modified alt-text onto the image 1104 is in addition to displaying the modified alt-text 1110. In some embodiments, a callout (e.g., an arrow) is displayed on the image 1104 in relation to the modified alt-text 1110 to show parts of the image 1104 are green, pink, or yellow as described in the modified alt-text 1110. In some embodiments, the callouts displayed on the image 1104 are in addition to displaying the modified alt-text 1110.

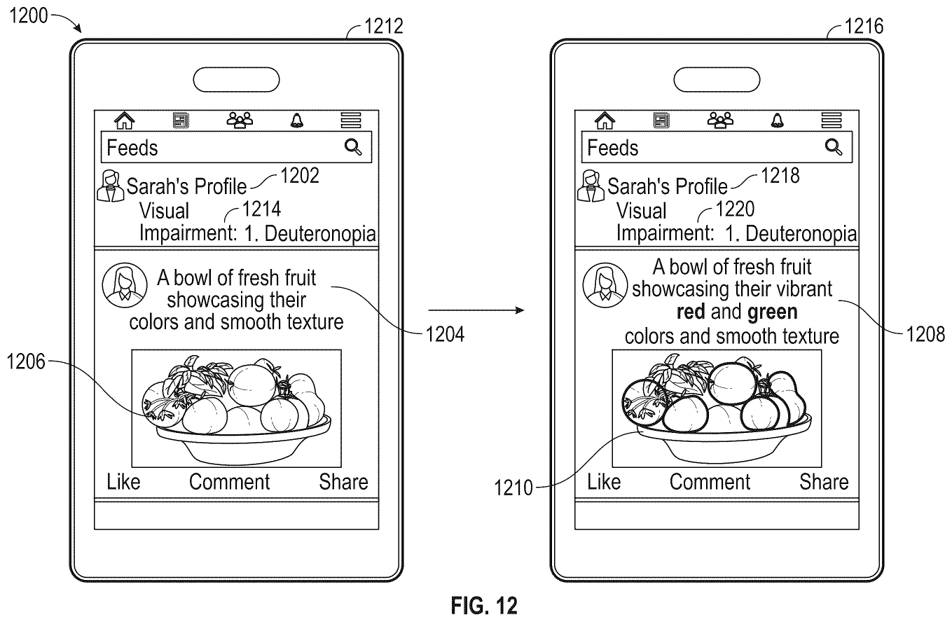

FIG. 12 is an illustrative example of a graphical interface generating tailored descriptions of content based on a visual impairment corresponding to a color blindness visual impairment, in accordance with some embodiments of this disclosure. FIG. 12, in some embodiments is implemented by the ACD system 100 of FIG. 1 and 200 of FIG. 2.

In some embodiments, a graphical interface 1200 is provided for output at, for example, Sarah's device 1212. In some embodiments, Sarah's device 1212, is communicatively coupled to a server (e.g., server 804 of FIG. 8), e.g., via network 809 of FIG. 8. In this manner, server 804 of FIG. 8 may provide to Sarah's device 1212 an application interface. As is illustrated in this example, using the credentials associated with the application, Sarah has logged into the application in which her account corresponds to a profile 1202. Further, in this example, Sarah's profile comprises data corresponding to a visual impairment qualifier, e.g., a Deuteranopia visual impairment 1214. Even further, the graphical interface of the application shows a feed in which someone she is connected to through the application, has posted a photo 1206 and a description of the photo 1204, e.g., “a bowl of fresh fruit showcasing their colors and smooth texture.” In some embodiments, the graphical interface of Sarah's device 1212, outputs a graphical interface of an application with the original photo 1206 and the original description of the photo 1204, without applying the techniques discussed in previous figures to generate tailored descriptions based on the identified visual impairment associated with the computing device.

In some embodiments, the graphical interface 1216 of Sarah's device outputs a graphical interface of an application with a tailored photo 1210 and the modified description of the photo 1208, by applying the techniques discussed in previous figures to generate tailored descriptions based on the identified visual impairment associated with the computing device. As illustrated in this example, using the credentials associated with the application, Sarah has logged into the application in which her account corresponds to a profile 1218.

Further, in this example, Sarah's profile comprises data corresponding to a visual impairment qualifier, e.g., a Deuteranopia visual impairment 1220. Even further, the graphical interface of the application shows a feed in which someone she is connected to through the application, has posted a photo 1206 and a description of the photo 1204, e.g., “a bowl of fresh fruit showcasing their colors and smooth texture.”

In some embodiments, the ACD system, using the methods and systems discussed in previous figures to generate alt-text based on an identified visual impairment qualifier associated with a computing device, alters both the image and the corresponding description. As illustrated on the graphical interface 1212, the ACD system has not applied any modifications to the original description 1204 and the original image 1206, even though a visual impairment has been identified corresponding to Sarah's profile. In some embodiments, as in this example, the graphical interface would make it difficult for Sarah to distinguish between the red and the green tomatoes. In some embodiments, as illustrated by the graphical interface 1216, the ACD system modifies both the image 1210 and the description 1206 based on the identified visual impairment qualifier associated with a computing device (e.g., Deuteranopia colorblindness).

As illustrated in this example, the ACD system has highlighted (e.g., drew boundaries around the objects) the tomatoes it has identified as Sarah being unable to distinguish in the image 1208 based on her visual impairment type of deuteranopia. Further, the ACD system has altered the original text, bolded, and modified the color of the text to draw attention to the relevant portions of the description. In some embodiments, the ACD system updates the text related to the relevant part of the description which has been modified is updated to a color that is able to be recognized by a visual impairment deficiency.

In some embodiments, the ACD system modifies the image and the description of the image to include a unique visual identifier. In some embodiments the unique visual identifier corresponds to the details about the object the ACD system has identified as problematic based on the identified visual impairment type. In some embodiments, the unique visual identifier comprises a color, a pattern, a shape, a font, a bolding, or a label. For example, as illustrated in the graphical interface 1216, both the modified text of “red and green” and the highlighted objects identified within the image both are the same color to help the reader understand what has been modified within the original image and description. In some embodiments, if two or more colors are described within the modified text, the two or more colors may be displayed in different colors, considering the accessibility profile associated with the user. For example, the modified text of “red” may be displayed in a gold color along with the outline of the red tomato also being displayed in a gold color. Continuing with this same example, the modified text of “green” may be displayed in a blue color along with the outline of the green tomato also being displayed in the blue color.

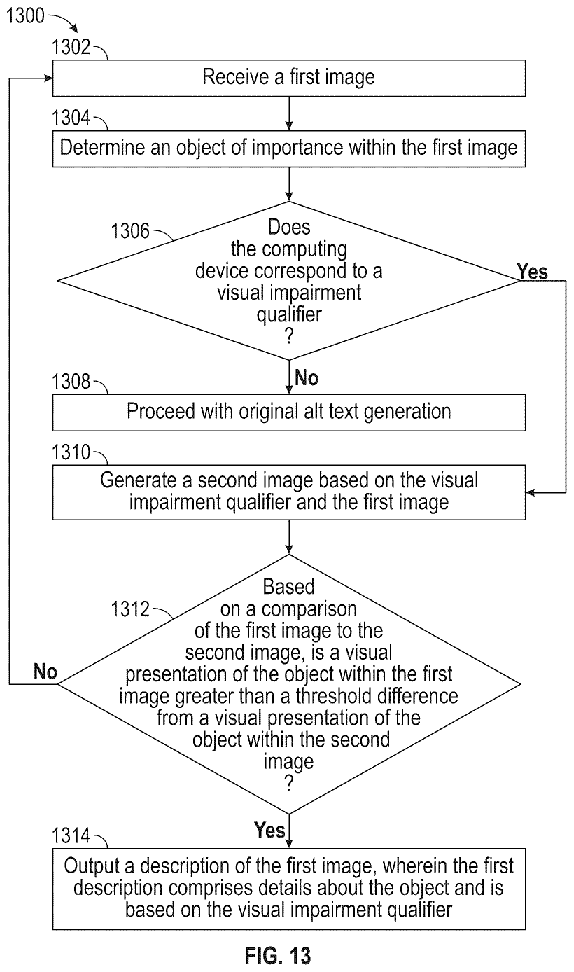

FIG. 13 is a flowchart of a detailed illustrative process for creating tailored descriptions of content based on a visual impairment corresponding to a color blindness visual impairment 1300, in accordance with some embodiments of this disclosure. In various embodiments, the individual steps of process 1300 may be implemented by one or more components of the devices, methods and systems of FIGS. 1-12 and may be performed in combination with any of the other processes and aspects described herein. Although the present disclosure may describe certain steps of process 1300 (and of other processes described herein) as being implemented by certain components of the devices, methods, and systems of FIGS. 1-12, this is for purposes of illustration only, and it should be understood that other components of the devices, methods, and systems of FIGS. 1-12 may implement those steps instead.

At 1302, input/output (“I/O”) circuitry (e.g., I/O path 812 of FIG. 8 and/or of IO path 902 of FIG. 9) of a computing device may receive from a server (e.g., server 804 of FIG. 8), a first image (e.g., image 102 of FIG. 1 and/or image 202 of FIG. 2). For example, a computing device may receive an image of a bowl filled with tomatoes.

At 1304, control circuitry (e.g., control 811 of FIG. 8 and/or control circuitry 904 of 15 FIG. 9) may determine an object of importance within the first image. For example, control circuitry may determine that the red and green tomatoes within the bowl are objects of importance within the image.

At 1306, control circuitry determines whether the computing device corresponds to a visual impairment qualifier. For example, the computing device may correspond to a profile with a visual impairment qualifier of protanopia color blindness. In response to determining that the computing device does not correspond to a visual impairment, control circuitry proceeds to 1308 in which the original alt-text is output. For example, the original alt-text corresponding to an image with a bowl filled with tomatoes is output, such as “a bowl filled with fresh tomatoes showcasing their vibrant color and smooth texture.” In response to determining that the computing device does correspond to a visual impairment, control circuitry proceeds to 1310 in which a second image is generated based on the visual impairment qualifier and the first image. For example, if the visual impairment qualifier corresponds to a protanopia color blindness, a second image is generated to simulate the protanopia color blindness by reducing or removing the sensitivity to red light, altering colors in the image to simulate how red hues blend into green or grays.

At 1306, control circuitry, based on a comparison of the first image to the second, simulated image, determines whether the visual presentation of the object within the first image is greater than a threshold difference from a visual presentation of the object within the second image. For example, control circuitry performs a comparative analysis between the first, original image and the second, simulated image to calculate color differences which quantifies the difference between two colors as perceived by the human eye. Following the example of the bowl filled with tomatoes, the red and the green tomatoes appear similar in the second, simulated image compared to the visual presentation of the red and green tomatoes in the first, original image. In response to determining that the visual presentation of the object within the first image is not greater than a threshold difference from a visual presentation of the object within the second image, control circuitry proceeds to 1302, to receive an image and perform the steps of 1302-1312. In response to determining that the visual presentation of the object within the first image is greater than a threshold difference from a visual presentation of the object within the second image, control circuitry proceeds to 1314, to output a description of the first image, wherein the description comprises details about the object and is based on the visual impairment qualifier. For example, continuing with the example of the image of the tomatoes in the bowl, a modified description of the image based on the visual impairment qualifier protanopia color blindness, would replace the original description to highlight the regions flagged as visually challenging. The original description “a bowl filled with fresh tomatoes showcasing their vibrant color and smooth texture” would be replaced with the modified text “a bowl filled with fresh tomatoes showcasing their vibrant red and green colors and smooth texture.”

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving a first image;
determining, using a machine learning model, a first object of importance within the first image;
identifying a visual impairment qualifier corresponding to a computing device;
generating, using a processing filter, a second image based on the visual impairment qualifier and the first image;
based at least in part on a comparison of the first image to the second image, determining that a visual presentation of the first object within the first image is greater than a threshold difference from a visual presentation of the first object within the second image; and
based at least in part on determining that the visual presentation of the first object within the first image is greater than the threshold difference from the visual presentation of the first object within the second image, causing to be output a first description of the first image, wherein the first description comprises details about the first object and is based on the visual impairment qualifier.

2. (canceled)

3. The method of claim 1, wherein the visual impairment qualifier corresponds to a color blindness visual impairment, wherein the generating the second image further comprises:
transforming, using the processing filter, the first image into a uniform color space; and
modifying, using the processing filter, the first image with a visual impairment matrix, wherein the visual impairment matrix is based on the visual impairment qualifier.

4. The method of claim 1, wherein the visual impairment qualifier corresponds to a color blindness visual impairment, the comparison of the first image to the second image further comprises:
identifying the first object of importance within the second image;
calculating a color difference between the first object of importance within the first image and the first object of importance within the second image;
based at least in part on determining that the color difference is above a threshold, determining that the visual presentation of the first object within the first image is greater than the threshold difference from the visual presentation of the first object within the second image.

5. The method of claim 1, further comprising:
predicting, using the machine learning model, a region of importance of a plurality of regions of the first image based on a color, texture, or spatial layout of the region being visually distinguishable from one or more other regions of the plurality of regions;
determining the first object of importance is located within the region of importance; and
based at least in part on determining the first object of importance is located within the region of importance and determining that the visual presentation of the first object within the first image is greater than the threshold difference from the visual presentation of the first object within the second image, including details of the first object of importance and the region of importance in the first description of the first image.

6. The method of claim 1, wherein determining, using the machine learning model, the first object of importance within the first image further comprises:
identifying, using the machine learning model, a plurality of objects within the first image;
extracting, using the machine learning model, features of each of the identified plurality of objects within the first image;
based at least in part on the extracted features of the identified plurality of objects within the first image, determining context associated with the identified plurality of objects;
ranking the plurality of objects based on a determined context; and
determining the first object of importance based at least in part on the ranking of the plurality of objects.

7. The method of claim 1, wherein the visual impairment qualifier corresponds to a contrast insensitivity visual impairment, wherein generating the second image further comprises transforming, using the processing filter, the first image into a luminance-based color space.

8. The method of claim 1, wherein:
the visual impairment qualifier corresponds to a contrast insensitivity visual impairment;
the comparison of the first image to the second image further comprises:
identifying a second object of importance within the second image;
determining, using the machine learning model, one or more low contrast regions of a plurality of regions within the second image; and
determining that the second object of importance is within the one or more low contrast regions; and
the method further comprises, based at least in part on determining that the second object is within the one or more low contrast regions, and that the visual presentation of the first object within the first image is greater than the threshold difference from the visual presentation of the first object within the second image, causing to be output the first description of the first image comprising the details about the first object and the second object.

9. The method of claim 1, wherein:
the visual impairment qualifier corresponds to a contrast insensitivity visual impairment,
the comparison of the first image to the second image further comprises:
identifying the first object of importance within the second image; and
calculating a brightness difference between the first object of importance within the first image, and the first object of importance within the second image; and
the determining that the visual presentation of the first object within the first image is greater than the threshold difference from the visual presentation of the first object within the second image is based at least in part on determining that the brightness difference is above a threshold.

10. The method of claim 1, wherein the first description of the first image based on the visual impairment qualifier is output simultaneously with the first image.

11. The method of claim 1, further comprising receiving a second description comprising alt-text corresponding to the first image, wherein the second description is different from the first description, the method further comprising:
transmitting, to a service, data comprising the second description and the visual impairment qualifier;
receiving, from the service the first description of the first image; and
replacing the alt-text corresponding to the first image with the first description.

12-18. (canceled)

19. A system comprising:
input/output circuitry configured to:
receive a first image;
control circuitry configured to:
determine, using a machine learning model, a first object of importance within the first image;
identify a visual impairment qualifier corresponding to a computing device;
generate, using a processing filter, a second image based on the visual impairment qualifier and the first image;
based at least in part on a comparison of the first image to the second image, determine that a visual presentation of the first object within the first image is greater than a threshold difference from a visual presentation of the first object within the second image; and
wherein the input/output circuitry is further configured to:
based at least in part on determining that the visual presentation of the first object within the first image is greater than the threshold difference from the visual presentation of the first object within the second image, cause to be output a first description of the first image, wherein the first description comprises details about the first object and is based on the visual impairment qualifier.

20. (canceled)

21. The system of claim 19, wherein the visual impairment qualifier corresponds to a color blindness visual impairment, and wherein the control circuitry configured to generate the second image is further configured to:
transform, using the processing filter, the first image into a uniform color space; and
modify, using the processing filter, the first image with a visual impairment matrix, wherein the visual impairment matrix is based on the visual impairment qualifier.

22. The system of claim 19, wherein the visual impairment qualifier corresponds to a color blindness visual impairment, and wherein the control circuitry configured to perform the comparison of the first image to the second image is further configured to:
identify the first object of importance within the second image;
calculate a color difference between the first object of importance within the first image and the first object of importance within the second image; and
based at least in part on determining that the color difference is above a threshold, determine that the visual presentation of the first object within the first image is greater than the threshold difference from the visual presentation of the first object within the second image.

23. The system of claim 19, wherein the control circuitry is further configured to:
predict, using the machine learning model, a region of importance of a plurality of regions of the first image based on a color, texture, or spatial layout of the region being visually distinguishable from one or more other regions of the plurality of regions;
determine the first object of importance is located within the region of importance; and
based at least in part on determining the first object of importance is located within the region of importance and determining that the visual presentation of the first object within the first image is greater than the threshold difference from the visual presentation of the first object within the second image, include details of the first object of importance and the region of importance in the first description of the first image.

24. The system of claim 19, wherein the control circuitry configured to determine the first object of importance within the first image using the machine learning model is further configured to:
identify, using the machine learning model, a plurality of objects within the first image;
extract, using the machine learning model, features of each of the identified plurality of objects within the first image;
based at least in part on the extracted features of the identified plurality of objects within the first image, determine context associated with the identified plurality of objects;
rank the plurality of objects based on a determined context; and
determine the first object of importance based at least in part on the ranking of the plurality of objects.

25. The system of claim 19, wherein the visual impairment qualifier corresponds to a contrast insensitivity visual impairment, wherein the control circuitry configured to generate the second image is further configured to transform, using the processing filter, the first image into a luminance-based color space.

26. The system of claim 19, wherein:
the visual impairment qualifier corresponds to a contrast insensitivity visual impairment;
the control circuitry, to perform the comparison of the first image to the second image, is further configured to:
identify a second object of importance within the second image;
determine, using the machine learning model, one or more low contrast regions of a plurality of regions within the second image; and
determine that the second object of importance is within the one or more low contrast regions; and
the input/output circuitry is further configured to:
based at least in part on determining that the second object is within the one or more low contrast regions, and that the visual presentation of the first object within the first image is greater than the threshold difference from the visual presentation of the first object within the second image, cause to be output the first description of the first image comprising the details about the first object and the second object.

27. The system of claim 19, wherein:
the visual impairment qualifier corresponds to a contrast insensitivity visual impairment;
the control circuitry, to perform the comparison of the first image to the second image, is further configured to:
identify the first object of importance within the second image;
calculate a brightness difference between the first object of importance within the first image, and the first object of importance within the second image; and
determine that the visual presentation of the first object within the first image is greater than the threshold difference from the visual presentation of the first object within the second image based at least in part on determining that the brightness difference is above a threshold.

28. The system of claim 19, wherein the input/output circuitry is further configured to cause to be output the first description of the first image based on the visual impairment qualifier simultaneously with the first image.

29. The system of claim 19, wherein the control circuitry is further configured to:
receive a second description comprising alt-text corresponding to the first image, wherein the second description is different from the first descriptions;
transmit, to a service, data comprising the second description and the visual impairment qualifier;
receive, from the service the first description of the first image; and
replace the alt-text corresponding to the first image with the first description.

30-90. (canceled)
